(19) United States
(12) Patent Application Publication
(10) Pub. No.: US 2002/0008676 A1
(43) Pub. Date: Jan. 24, 2002

(54) Three-dimensional image display apparatus, three-dimensional image display method and data file format

(75) Inventors: Makoto Miyazaki, Osaka (JP); Ken Yoshii, Itami-shi (JP); Manami Kuiseko, Kyoto-Shi (JP)

Correspondence Address: McDERMOTT, WILL & EMERY, 600 13th Street, N.W., Washington, DC, 20005, US

(73) Assignee: MINOLTA CO., LTD.

(21) Appl. No.: 09/867,554

(22) Filed: May 31, 2001

(30) Foreign Application Priority Data
Jun. 1, 2000 (JP) P2000-164132

(51) Int. Cl. G09G 5/00

(52) U.S. Cl. 345/6

(57) ABSTRACT

Dimensional data representing the actual dimension of a display subject is added to two-dimensional image data representing cross-sectional images, and upon displaying a three-dimensional image, the dimensional data is referred so that in the case of equal magnification, a variable magnification process is carried out by using a zoom optical system on a display subject; thus, an image is projected onto a screen with its display size having virtually the actual dimension of the display subject, and a character “magnification×1” is displayed on a liquid crystal display. In the same manner, when the user sets a magnification of ½, an image is projected onto the screen with its display size reduced to ½ of the actual dimension, and a character “magnification×½” is displayed on the liquid display.

This application is based on application No. 2000-164132 filed in Japan, the contents of which are hereby incorporated by reference.

### BACKGROUND OF THE INVENTION

1. Field of the Invention

The present invention relates to a three-dimensional image display apparatus for displaying a three-dimensional image of a display subject, a three-dimensional image display method and a data file format.

2. Description of the Background Art

Conventionally, a three-dimensional image display apparatus for displaying a three-dimensional image of a display subject has been known. One of typical examples is an apparatus disclosed in Japanese Patent Application Laid-Open No. 5-22754, in which two-dimensional image data of cross-sectional images of a display subject is prepared, and by using a volume scanning method, these cross-sectional images of the display subject are successively projected onto a screen which periodically scans a predetermined three-dimensional space so as to provide a three-dimensional image display.

However, in the above-mentioned conventional apparatus, in most cases, upon projecting the cross-sectional images onto the screen, the size of the three-dimensional image and the size of the display object are not coincident with each other due to factors such as magnifications of various optical systems and pixel sizes of display elements, resulting in a failure to represent the actual size of the display subject.

### SUMMARY OF THE INVENTION

The present invention is related to a three-dimensional image display apparatus.

One aspect of the present is directed to a three-dimensional image display apparatus that is provided with: a screen for periodically shifting within a predetermined three-dimensional space; an image data acquiring section for acquiring a group of two-dimensional image data that collectively represents a display subject by using a plurality of cross-sectional images; a dimension acquiring section for acquiring dimensional data that represents an actual dimension of the display subject that is associated with the group of two-dimensional image data; a cross-sectional image generation section for successively generating the plurality of cross-sectional images based upon the group of two-dimensional image data; a projection section for projecting the cross-sectional images generated by the cross-sectional image generation section on the screen; an optical variable magnification section for carrying out a variable optical magnification on the cross-sectional images between the display section and the projection section; and a variable magnification control section for controlling the magnification set by the optical variable magnification section so as to allow a three-dimensional image displayed on the screen to virtually have an actual dimension of the display subject. Consequently, it is possible to confirm the actual size of the display subject, and based upon the dimensional data, the magnification is controlled by the optical variable magnification section so as to allow the three-dimensional image displayed on the screen to have virtually the actual dimension of the display subject; therefore, as compared with the variable magnification using the alteration of the number of pixels, it is possible to provide a better three-dimensional image display with higher quality.

In one preferred embodiment of the present invention, the three-dimensional image display apparatus is provided with: a screen for periodically shifting within a predetermined three-dimensional space; an image data acquiring section for acquiring a group of two-dimensional image data that collectively represents a display subject by using a plurality of cross-sectional images; a dimension acquiring section for acquiring dimensional data that is associated with the group of two-dimensional image data; a cross-sectional image display section for successively displaying the plurality of cross-sectional images based upon the group of two-dimensional image data; a projection section for projecting the cross-sectional images generated by the cross-sectional image generation section; and a pixel-number alteration section for altering the number of pixels contained in respective two-dimensional image data in the group of two dimensional image data so as to allow a three-dimensional image displayed on the screen to have an actual dimension of the display subject. In this arrangement, the pixel-number alteration section, which alters the number of pixels contained in the respective two-dimensional image data in the groups of two-dimensional data is changed so as to allow a three-dimensional image displayed on the screen to have the actual dimension of the display subject, is installed; therefore, it is possible to eliminate the need of an optical variable magnification system that is more expensive than the pixel-number alteration section, and consequently to reduce the manufacturing costs to provide an inexpensive apparatus.

Moreover, the present invention is also related to a three-dimensional image display method and a data file format.

Therefore, the objective of the present invention is to provide a three-dimensional image display apparatus which allows the viewer to confirm an actual size of a display subject, and a three-dimensional image display method and a data file format for such an apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a drawing that shows an entire structure of a three-dimensional image display system in accordance with one preferred embodiment of the present invention;

FIG. 2 is a drawing that shows the outline of a three-dimensional image display apparatus;

FIGS. 3A, 3B and 3C are drawings that show the states of a display subject indicated in its actual dimension and ½ dimension;

FIG. 4 is an enlarged drawing that shows an operation switch that is detachably attached;

FIG. 5 is a drawing that shows a structure including an optical system in the three-dimensional image display apparatus;

FIG. 6 is a drawing that shows a structure of a double telecentric lens;

FIG. 7 is a perspective view that schematically shows a screen and a rotation member;

FIG. 8 is a drawing that shows a size of a cross-sectional image that is projected on the screen;

FIG. 9 is a block diagram that shows a functional structure of the three-dimensional display system;

FIGS. 10A, 10B and 10C are drawings that show structural examples of memories;

FIG. 11 is a drawing that shows a structural example of a memory in accordance with a preferred embodiment of the present invention;

FIG. 12 is a drawing that shows an essential part of the structure shown in FIG. 9;

FIGS. 13A and 13B are timing charts that show one example of the operations in the memories 63a and 63b;

FIG. 14 is a block diagram that shows that specifically shows a memory control section;

FIG. 15 is a block diagram that shows a functional structure of a host computer shown in FIG. 9;

FIGS. 16A, 16B, 16C and 16D are drawings that show conversion processes from three-dimensional image data to two-dimensional image data that are carried out in a cross-sectional image computing section;

FIGS. 17A and 17B are drawings that show one example of correction in the cross-sectional image (projection image);

FIGS. 18A and 18B are drawing that show the order of reading processes in the memories 63a and 63b carried out in response to the rotation angle θ of the screen;

FIG. 19 is a drawing that shows one example of a control mechanism for switching the order of reading processes of two-dimensional image data;

FIGS. 20A and 20B are drawings that show one example of an 8-bit horizontal address signal generated in address generation sections 82a and 82b;

FIG. 21 is a flow chart that shows a sequence of processes that is carried out when a three-dimensional image is actually displayed in the three-dimensional image display apparatus;

FIG. 22 is a flow chart that more specifically shows the three-dimensional image display;

FIG. 23 is a flow chart that relates to display processes in the case when a still image is used as an image to be three-dimensionally displayed;

FIG. 24 is a flow chart that shows a sequence of processes that are carried out when a three-dimensional image is actually displayed in the three-dimensional image display apparatus; and

FIG. 25 is a drawing that shows an essential portion of a three-dimensional image display system in accordance with a second preferred embodiment.

### DESCRIPTION OF THE PREFERRED EMBODIMENTS

Referring to Figures, the following description will discuss preferred embodiments of the present invention.

### 1. First Preferred Embodiment

### A. Entire System Construction

FIG. 1 shows the entire construction of a three-dimensional image display system that is one preferred embodiment of a three-dimensional image display system of the present invention. This three-dimensional image display system 1 is provided with a three-dimensional image display apparatus 100 for providing a three-dimensional display of a display subject by using a volume scanning method and a host computer 3 that supplies two-dimensional image data related to cross-sectional images of the display subject to the three-dimensional image display apparatus 100.

The three-dimensional image display apparatus 100 intermittently projects cross-sectional images of a display subject onto a screen that rotates at a high speed centered on a predetermined rotation axis, as will be described later, so that an after-image effect is exerted to display a three-dimensional image. Further, by updating the cross-sectional images to be projected depending on the position (angle) of the rotating screen, various three-dimensional images of the display subject are displayed.

The host computer 3 is a generally-used computer, which is constituted by a CPU 3a, a display 3b, a keyboard 3c and a mouse 3d. The host computer 3 is provided with software that carries out a process for generating two-dimensional image data of a cross-sectional image corresponding to each angle at the time when the screen rotates, from three-dimensional image data of a display subject that has been preliminarily inputted. Therefore, the host computer 3 is allowed to generate two-dimensional image data related to a cross-sectional image of the display subject to be projected onto the screen in response to the rotation angle of the screen, from the three-dimensional image data of the display subject, and the two-dimensional image data thus generated is supplied to the three-dimensional image display apparatus 100.

On-line data communication is available between the host computer 3 and the three-dimensional image display apparatus 100, and off-line data communication is also available through a portable recording medium 4. Examples of such a recording medium include a magneto-optical disk (MO), a compact disk (CD-RW), a digital video disk (DVD-RAM), a memory card, etc.

### B. Three-dimensional Image Display Apparatus

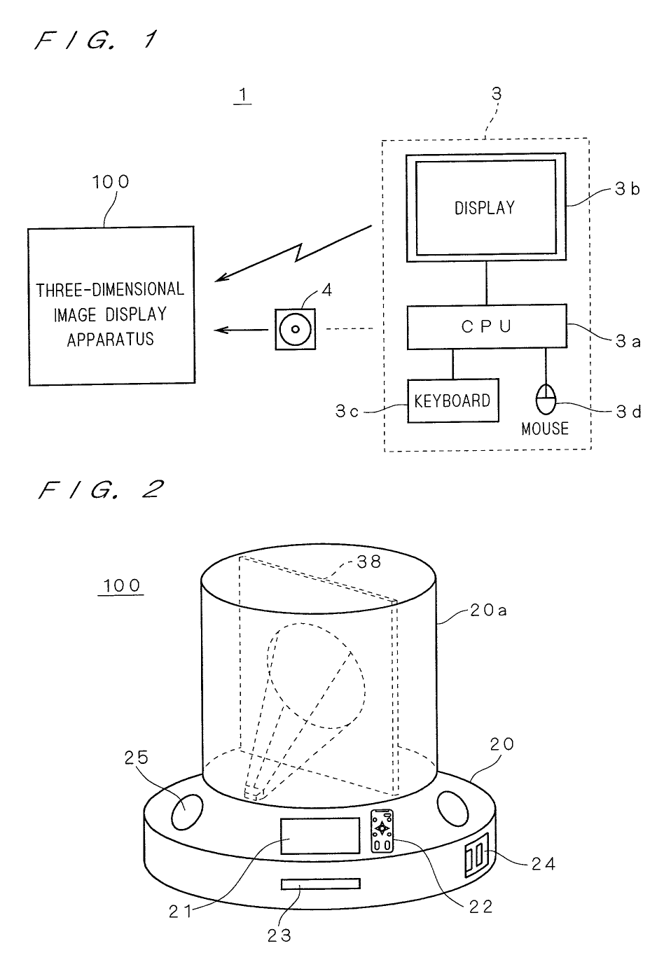

Next, an explanation will be given of one preferred embodiment of the three-dimensional image display apparatus 100. FIG. 2 is a drawing that schematically shows the appearance of the three-dimensional display apparatus 100. This three-dimensional image display apparatus 100 is provided with a housing 20 containing an optical system for projecting a cross-sectional image on a screen 38, a control mechanism for carrying out various kinds of data processing and a cylinder-shaped windshield 20a that is installed on the upper side of the housing 20, and contains a rotating screen therein.

The windshield 20a is made of a transparent material such as glass and acrylic resin, and designed so that a cross-sectional image projected on the screen 38 rotating inside thereof is viewed from outside. Moreover, the windshield 20a shields the inner space in such a manner that the rotation of the screen 38 is stabilized and the power consumption of the motor used for rotative driving operation is reduced.

On the front face side of the housing 20, a liquid crystal display (LCD) 21, an operation switch 22 that is detachably attached thereto and an attaching inlet 23 for a recording medium 4 are placed, and on the side face thereof, a digital input-output terminal 24 is installed. The liquid crystal display 21 is used as a display element for an operation guiding screen used for receiving operational inputs as well as for a two-dimensional image used for an index of a display subject. The digital input-output terminal 24 includes terminals such as an SCSI terminal and an IEEE 1394 terminal. Moreover, speakers 25 used for sound output are placed at four portions on the outer circumferential face of the housing 20.

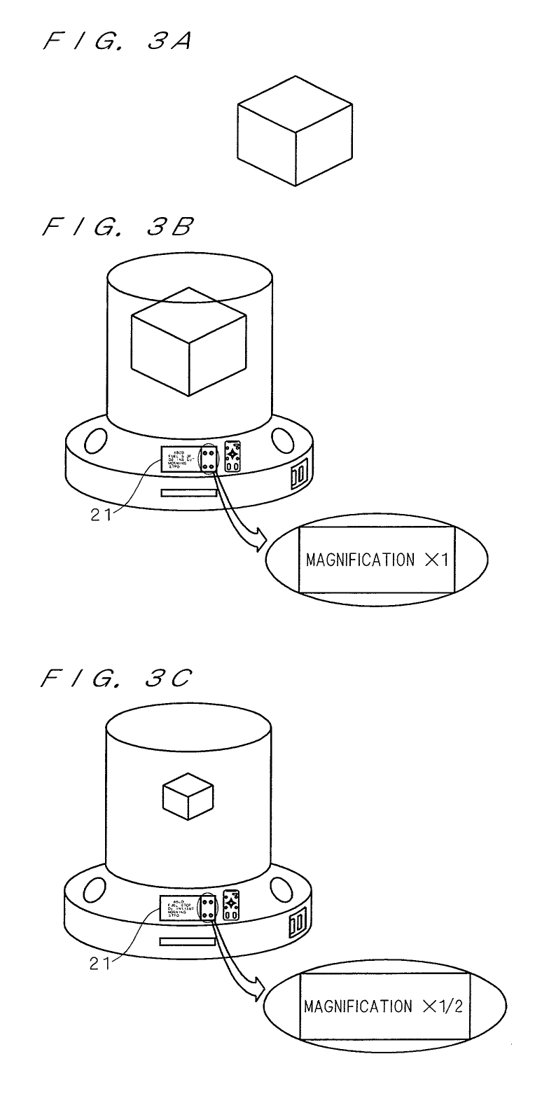

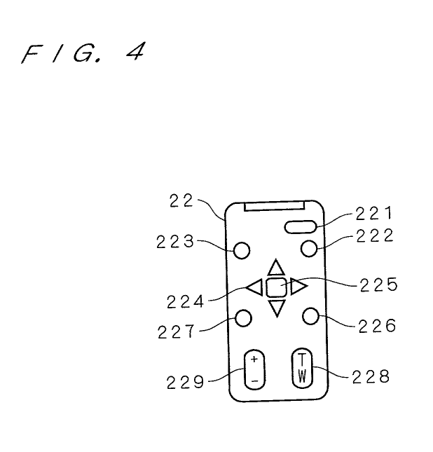

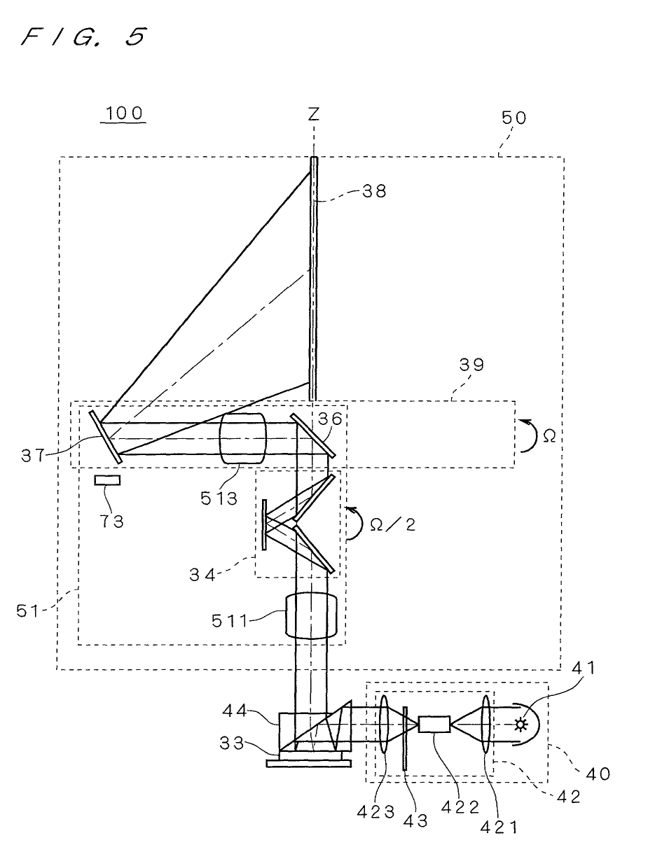

FIG. 4 is an enlarged view of the operation switch 22 that is detachably attached. The operation switch 22, which functions as an operation input element for inputting various operational parameters, is provided with various buttons placed thereon, such as a power-switch button 221, a start button 222, a stop button 223, a cursor button 224, a select button 225, a cancel button 226, a menu button 227, a zoom button 228 and a volume control button 229. FIGS. 3A, 3B and 3C are drawings that respectively show a display subject and displayed states thereof in its actual size and ½ size. In the present preferred embodiment, dimensional data that represents an actual dimension of a display subject is added to the two-dimensional image data representing the cross-sectional image, and the display of the three-dimensional image, which will be described later, is controlled by using this data so that it is possible to recognize the actual size of the display subject from the displayed three-dimensional image.

More specifically, with respect to a display subject as illustrated in FIG. 3A, in the case when a three-dimensional display thereof is provided in its actual size as shown in FIG. 3B, a character “Magnification×1” indicating its set magnification is displayed on the liquid crystal display 21. In the same manner, as illustrated in FIG. 3C, in the case when a three-dimensional display thereof is provided in its ½ size, a character “Magnification×½” indicating its set magnification is displayed on the liquid crystal display 21. In this manner, in the three-dimensional image display system in accordance with the present preferred embodiment, by using the dimensional data, it is possible to provide a display that represents the actual size of the display subject.

The display of a three-dimensional image on the screen 38 is started by selecting two-dimensional image data to be three-dimensionally displayed from data file recorded in the recording media 4 using respective buttons 221 to 227 of the operation switch 22, or selecting two-dimensional image data from data file stored on the host computer 3 side.

Next, an explanation will be given of an optical system for projecting a cross-sectional image on the screen 38 in the three-dimensional display apparatus 100. FIG. 5 is a drawing that shows a construction including an optical system in the three-dimensional image display apparatus 100. As illustrated in FIG. 5, this optical system in the three-dimensional image display apparatus 100 is provided with an illuminating optical system 40, a projection optical system 50, a DMD (digital-micromirror-device) 33 and a TIR prism 44.

First, an explanation will be given of the DMD 33. The DMD 33 functions as an image generation element for generating a cross-sectional image to be projected onto the screen 38, and the DMD 33 has a structure in which minute mirrors, each of which is made of a metal piece (for example, aluminum piece) having a rectangular shape one side of which is approximately 16 μm, and serves as a pixel, are affixed on a plane in a scale having several hundred thousands of pieces per chip, and this device is controlled by an electrostatic field function of the output of SRAMs placed right under the respective pixels so that the tilt angle of each mirror is changed within the range of ±10 degrees. Here, the mirror tilt angle is ON/OFF controlled in a binary manner in response to “1” and “0” of the SRAM output, and upon receipt of light from a light source, only light reflected by those mirrors aligned in the ON (OFF) direction is allowed to proceed toward the projection optical system 50, while light reflected by those mirrors aligned in the OFF (ON) direction is directed out of the effective light path, and is not allowed to reach the projection optical system 50. This ON/OFF control of the mirrors generates a cross-sectional image corresponding to the distribution of ON/OFF mirrors, and this image is projected on the screen 38.

Here, the tilt angle of each mirror is controlled so as to switch the direction of the reflected light, and by adjusting this switching time (the length of reflection time), it is possible to express the density (gradation) of each pixel, and consequently to express 256 gradations for each color. Then, white light from a light source is allowed to pass through color filters of three colors, R(red), G(green) and B(blue), that are periodically switched, and the light rays of respective colors thus transmitted are made synchronous to DMD chips to form a color image, or DMD chips are prepared for the respective colors of R, G and B so that the light rays of the three colors are simultaneously projected to form a color image. Here, as will be described later, this apparatus is also capable of displaying a monochrome three-dimensional image; however, even in such a case, two-dimensional image data having a data format represented by color components of R, G and B is used.

The DMD 33 of this type has two major advantages; that is, first it has a high efficiency of use of light, and second, it has a high-speed responsivity. In general, this is applied to a video projector, etc., by utilizing its high efficiency of use of light.

In the present preferred embodiment, by utilizing the other major advantage of the DMD 33, that is, the high-speed responsivity, it is possible to display even a moving image of a display subject by using a volume scanning method utilizing after-image effects.

Since the responsivity of deflection of each mirror is approximately 10 μsec and since the writing operation for image data is carried out in the same manner as the generally-used SRAM, the DMD 33 makes it possible to provide an image at a very high speed, for example, 1 msec or less. Supposing that the speed is 1 msec, in the case when a volume scanning process of 180° at 1/18 second (that is, 9 revolutions per second) is carried out so as to achieve after-image effects, the number of cross-sectional images that can be generated is approximately 60. In comparison with a CRT, a liquid crystal display, etc., that is conventionally used as an image generation element for the volume scanning method, the DMD 33 makes it possible to project much more cross-sectional images on the screen 38 per unit time, and consequently to display not only a three-dimensional object having a non-rotation symmetric shape but also a moving image.

Moreover, the other advantage of the DMD 33, that is, the high efficiency of use of light, devotes to improve the after-image effects by projecting lighter cross-sectional images on the screen 38, thereby making it possible to display a three-dimensional image with higher quality as compared with the CRT system, etc.

Here, as illustrated in FIG. 5, on the image generation face side of the DMD 33, a TIR prism 44, which directs illuminated light from the illuminating optical system 40 to the minute mirrors, and also directs the plurality of cross-sectional images generated by the DMD 33 to the projection optical system 50, is placed.

The illuminating optical system 40 is provided with a white light source 41 and an illuminating lens system 42, and illuminating light from the white light source 41 is formed into parallel light rays by the illuminating lens system 42. The illuminating lens system 42 is constituted by a condenser lens 421, an integrator 422 , a color filter 43 and a relay lens 423. The illuminating light from the white light source 41 is converged by the condenser lens 421, and made incident on the integrator 422. Then, the illuminating light, which is allowed to have a uniform distribution in quantity of light by the integrator 422, is dispersed into any one of the R, G and B color components by the color filter 43 of a rotary type. The illuminating light, thus dispersed, is formed into parallel light rays by the relay lens 423, and then made incident on the TIR prism 44, and directed on the DMD 33.

Based upon two-dimensional image data given by a host computer 3, the DMD 33 changes the tilt angle of each minute mirror so that only some light components of the illuminating light required for projecting the cross-sectional images are reflected toward the projection optical system 50.

The projection optical system 50 is provided with a projection lens system 51 and a screen 38. This projection lens system 51 is provided with a double telecentric lens 511, a projection lens 513 and projection mirrors 36, 37 and an image rotation compensating mechanism 34. Among these, the projection lens 513 and the projection mirrors 36, 37 are placed inside a rotation member 39 that allows the screen 38 to rotate around a rotation axis Z.

The light (cross-sectional image) reflected by the DMD 33 is formed into parallel light rays by the double telecentric lens 511, and allowed to pass through the image rotation compensating mechanism 34 so as to be subjected to a rotation compensation for the cross-sectional image. The light rays that have been subjected to the rotation compensation in the image rotation compensating mechanism 34 are allowed to pass through the projection mirror 36, the projection lens 513 and the projection mirror 37, and then finally projected onto a main surface (projection surface) of the screen 38. Therefore, the projection optical system 50 and the DMD 33 constitute a projection image generation element which successively generates a plurality of cross-sectional images based upon two-dimensional image data, and successively projects the cross-sectional images on the screen in synchronism with the rotative scanning of the screen 38.

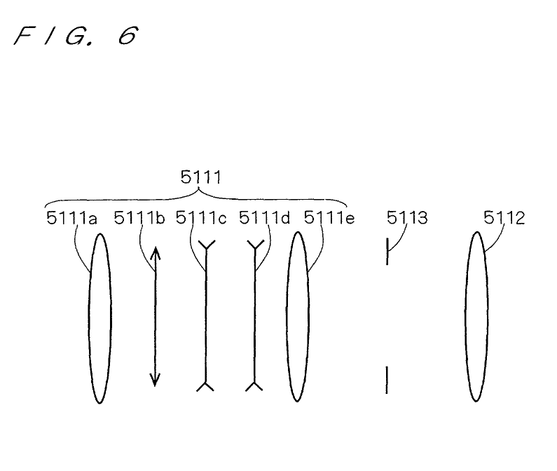

FIG. 6 shows the structure of the double telecentric lens 511. This includes main constituent components, such as incident-side lens group 5111, light-releasing side lens group 5112 and a diaphragm 5113.

Here, the incident-side lens group 5111 constitutes an afocal zoom optical system that makes the focal length on the incident side afocal, and the lens 5111b to 5111d are shifted by a lens controller, which will be described later, so that the display magnification is optically altered (increased or reduced). Moreover, this arrangement allows the double telecentric lens 511 to maintain its double telecentric property even in the case when a variable magnifying process is carried out.

In this optical system, the projection mirror 36, the projection lens 513, the projection mirror 37 and the screen 38 are fixed onto the rotation member 39, and these are rotated around the vertical rotary axis Z including the center axis of the screen 38 at an angular velocity of Ω, as the rotation member 39 rotates. In other words, upon rotating the screen 38 so as to carry out the volume scanning, the projection mirror 36, the projection lens 513 and projection mirror 37 placed inside the rotation member 39 are rotated integrally with the screen 38; therefore, independent of the angle of the screen 38, the projection of the cross-sectional images is always carried out from the front side.

Here, the rotation angle of the screen 38 is always detected by a position detector 73.

Thus, the cross-sectional images, generated by the DMD 33, are projected on the screen 38. The function of the projection lens 513 is to allow the light rays to form an appropriate image size before reaching the screen 38. Moreover, the projection mirror 37 is placed in such a position that it projects the cross-sectional images onto screen 38 from the position obliquely below on the front side thereof (from the inner side of the rotation member 39 in the case of FIG. 5) so as not to disturb the viewing field of the viewer upon observing the three-dimensional image projected onto the screen 38. Here, the positional order of the projection lens 513 with respect to the projection mirrors 36 and 37 is not intended to be limited by the present preferred embodiment.

Here, an explanation will be given of the image rotation compensating mechanism 34. The image rotation compensating mechanism 34, shown in FIG. 5, is realized by the structure of a so-called image rotator. When the rotation member 39 to which the screen 38 is attached is located with a certain rotation angle, a cross-sectional image projected on the screen 38 is set as a reference image. Supposing that no image rotation compensating mechanism 34 is used, the cross-sectional images being projected are in-plane rotated on the screen 38 as the rotation member 39 rotates, with the result that a cross-sectional image that is projected when the rotation member 39 has rotated 180° is given as an upside-down reversed image with respect to the reference image. The image rotation compensating mechanism 34 is used to prevent this phenomenon.

The image rotation compensating mechanism 34, shown in FIG. 5, uses an image rotator constituted by a plurality of mirrors combined therein. When the image rotator is rotated around the light axis, it has such a function that, in response to an incident image, a released image is allowed to rotate with an angular velocity twice as fast as the angular velocity of the image rotator. Therefore, by rotating the image rotator at an angular velocity of ½ of that of the rotation member 39 to which the screen 38 is attached, it becomes possible to always project an erecting cross-sectional image independent of the rotation of the screen.

Here, with respect to the image rotation compensating mechanism, besides the image rotator, a Dove(type) prism may be used with the same effects. Moreover, instead of using the image rotation compensating mechanism 34 used here, the cross-sectional image to be generated on the surface of the DMD 33 may be formed as an image rotating around the light axis in accordance with the rotation angle of the screen 38 so that the rotation of the projected image may be cancelled.

In other words, the two-dimensional image data for generating the cross-sectional image may be corrected at a stage before being given to the DMD 33 in such a manner that the resulting cross-sectional image generated on the surface of the DMD 33 is formed as an erecting image (or an inverted image) at the start of the volume scanning, and with the rotation of the screen 38, it rotates to form an inverted image (or an erecting image) upon completion of the volume scanning.

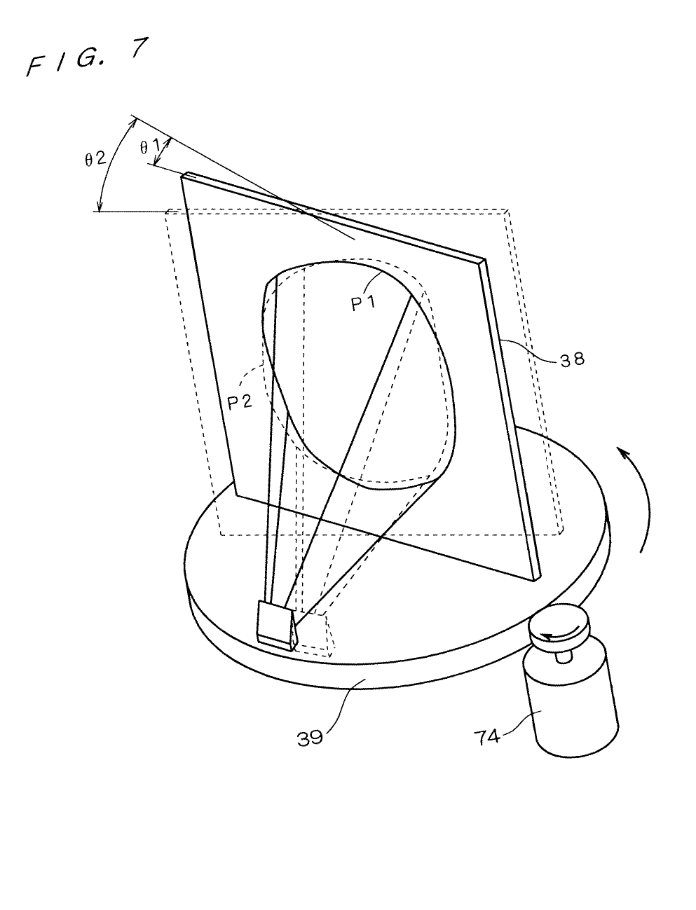

FIG. 7 is a schematic perspective view that shows one example of the screen 38 and the rotation member 39. As illustrated in FIG. 7, the rotation member 39 has a disc shape, and the rotary shaft of a motor 74 serving as a rotative driving element is made in contact with the side face thereof so that it is driven to rotate. Here, a motor may be directly connected to the center axis of the rotation member 39, or this may be driven by means of gears and belts.

As illustrated in FIG. 7, when the screen 38 is located with a rotation angle θ1, a cross-sectional image P1 (generated by the DMD 33) of the display subject corresponding to θ1 is projected onto the screen 38 through the projection mirror 36, the projection lens 513 and the projection mirror 37 shown in FIG. 5. After a lapse of an instantaneous time, the screen 38 is rotated, and when the rotation angle becomes θ2, a cross-sectional image P2 (generated by the DMD 33) of the display subject corresponding to θ2 is projected onto the screen 38 through the projection mirror 36, the projection lens 513 and the projection mirror 37 shown in FIG. 5.

The projection mirror 36, the projection lens 513 and the projection mirror 37 are commonly rotated with a fixed positional relationship with respect to the screen 38; thus, a cross-sectional image is always projected onto the screen 38 independent of the rotation thereof. Here, at the time when the rotation member 39 has been rotated 180° (or 360°), the same cross-sectional image as the starting image appears, thereby completing one volume scanning operation. When the above-mentioned processes are carried out with a sufficiently high speed of the rotation member 39 so as to cause the after-image effect, and when the number of the cross-sectional images to be projected is sufficiently increased, the viewer is allowed to observe a three-dimensional image of the display subject as an envelop of the cross-sectional images.

Next, an explanation will be given of the size (resolution) of the cross-sectional image. FIG. 8 is a drawing that shows a size of the cross-sectional image to be projected onto the screen 38. The cross-sectional image has a size of 256 pixels (horizontal direction)×256 pixels (vertical direction), and is projected symmetrically with respect to the rotation axis of the screen 38. In other words, the size consists of 128 pixels on each of the right and left sides in the circumferential direction with the rotation axis located in the center. The cross-sectional image thus projected is commonly rotated with a fixed relationship with respect to the screen 38 so that independent of the rotation of the screen 38, the size of the projected cross-sectional image is constant. Here, the size of the cross-sectional image shown in FIG. 8 is simply given as one example; and this may be set to a desired size depending on the number of minute mirrors installed on the DMD 33 to be used.

### C. Control Mechanism in the Three-dimensional Display Apparatus

Next, an explanation will be given of a control mechanism for displaying a three-dimensional image in the three-dimensional image display system 1.

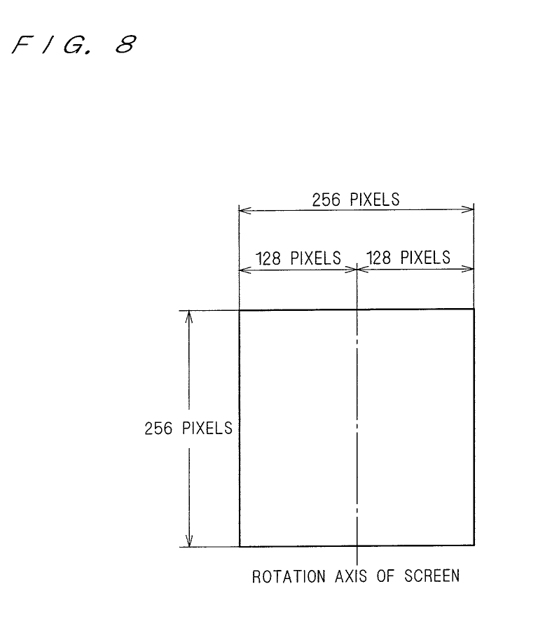

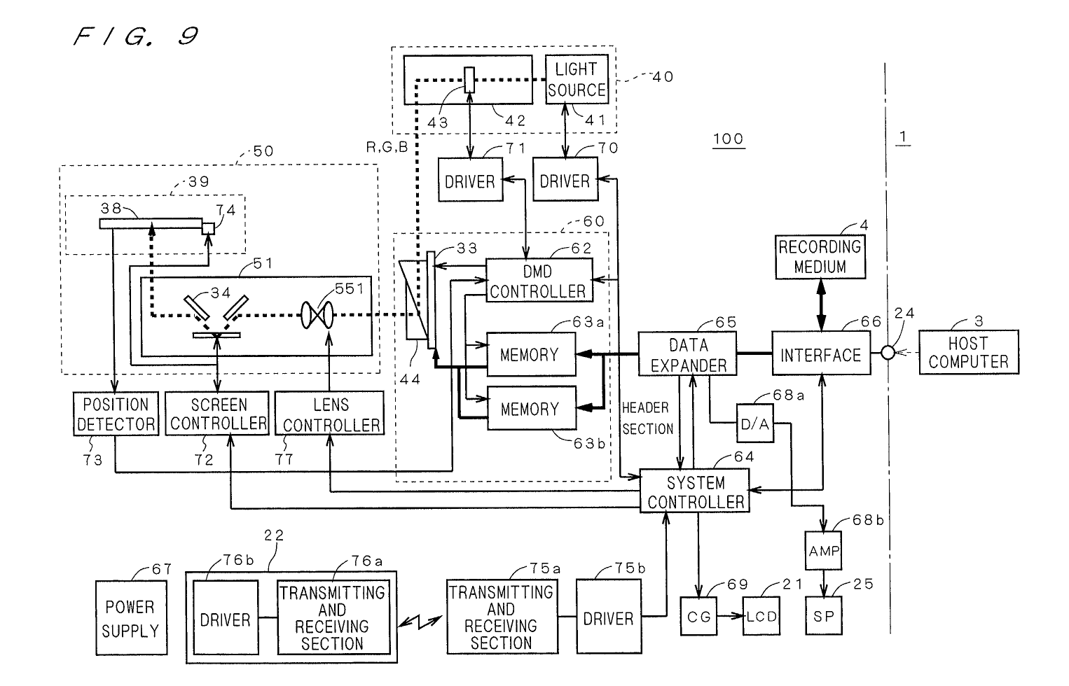

FIG. 9 is a block diagram that shows the functional structure of the three-dimensional display system 1. In FIG. 9, solid-line arrows indicate flows of electric signals, and broken-line arrows show flow of light. Here, in FIG. 9, the illuminating optical system 40 and the projection optical system 50 have the above-mentioned constructions.

Two-dimensional image data related to cross-sectional images of a display subject is inputted from the host computer 3 to the interface 66 through the digital input-output terminal 24, or from the recording medium 4 to the interface 66.

Since, in general, image data has more amount of data as compared with other kinds of data, the two-dimensional image data, inputted to the interface 66, has often been subjected to a data compression using an MPEG 2 system, etc. In this case, the compressed two-dimensional image data needs to be expanded (restored). Therefore, in the structure of FIG. 9, a data expander 65 for expanding the compressed two-dimensional image data. In the case of the two-dimensional image data to be inputted to the interface 66, which has not been data-compressed, it is not necessary to install the data expander 65.

The expanded two-dimensional image data is given to the DMD driving section 60 for controlling the generation of cross-sectional images in the DMD 33. The DMD driving section 60 is provided with the DMD 33, a DMD controller 62 and memories 63a, 63b. The memories 63a and 63b are designed so as to be independently controlled in their writing and reading operations, and allowed to function as storage element for storing plurality of two-dimensional image data respectively. The DMD controller 62 gives a gradation signal to the DMD 33, controls a driver 71 for driving the color filter 43 in response to the rotation angle of the screen 38 detected in the position detector 73, and also controls writing and reading operations in the memories 63a and 63b.

Here, an explanation will be given of the construction of a memory that serves as storage element. In the case when a volume scanning operation is carried out as described above, suppose that the number of cross-sectional images that can be generated in the DMD 33 is 60. In order to provide a three-dimensional display, the cross-sectional images are intermittently projected in response to the rotation angle of the screen 38 so that, supposing that one scene contains a group of cross-sectional images of 60 frames, the two-dimensional image data contained in the group of cross-sectional images needs to be successively transferred to the DMD 33 repeatedly. For this reason, in order to supply the two-dimensional image data to the DMD 33, the storage capacity of the memory needs to have a memory size capable of storing at least two-dimensional image data corresponding to 60 frames that are equivalent to one scene.

In other words, in the case when the memory size for the two-dimensional image data is small, that is, in the case when, for example, the memory can only store two-dimensional image data corresponding to cross-sectional images of less than 60 frames, it is not possible to properly provide a three-dimensional display even as a still image, unless two-dimensional image data is continued to be transferred repeatedly from the host computer 3 or the recording medium 4 every cross-sectional image. Since, in general, the rate of transfer of the two-dimensional image data from the host computer 3 or the recording media 4 is lower as compared with the rate at the time of supplying the two-dimensional image data from the memory to the DMD 33, the resulting problem is that the supply of the two-dimensional image data is not made in time for the rotation position of the screen 38 that rotates at high speeds, failing to properly display a three-dimensional image.

In contrast, in the case when there is a memory size corresponding to not less than 60 frames, all the two-dimensional image data related to the group of cross-sectional images constituting one scene is stored in the memory; therefore, once the two-dimensional image data has been stored in the memory, the two-dimensional image data is successively given from the memory to the DMD 33 in response to the rotation position of the screen 38 so that it is possible to properly display a three-dimensional image.

With respect to the above-mentioned fact, the same is true for both of the cases for displaying a still image and for displaying a moving image, upon providing a three-dimensional display.

Next, an explanation will be given of the memory construction in the case of displaying a moving image. When images are prepared for the respective color components of R, G and B so as to provide a color display, one set of these R, G and B images constitutes one frame of cross-sectional image. Therefore, when 60 frames are allocated to the respective color components of R, G and B, the images of each color component correspond to 20 frames. For this reason, the memory size required for forming one sheet of three-dimensional image is 256×256×3×20=3.75 Mbyte (=30 Mbit), in the case of the size of a cross-sectional image shown in FIG. 8.

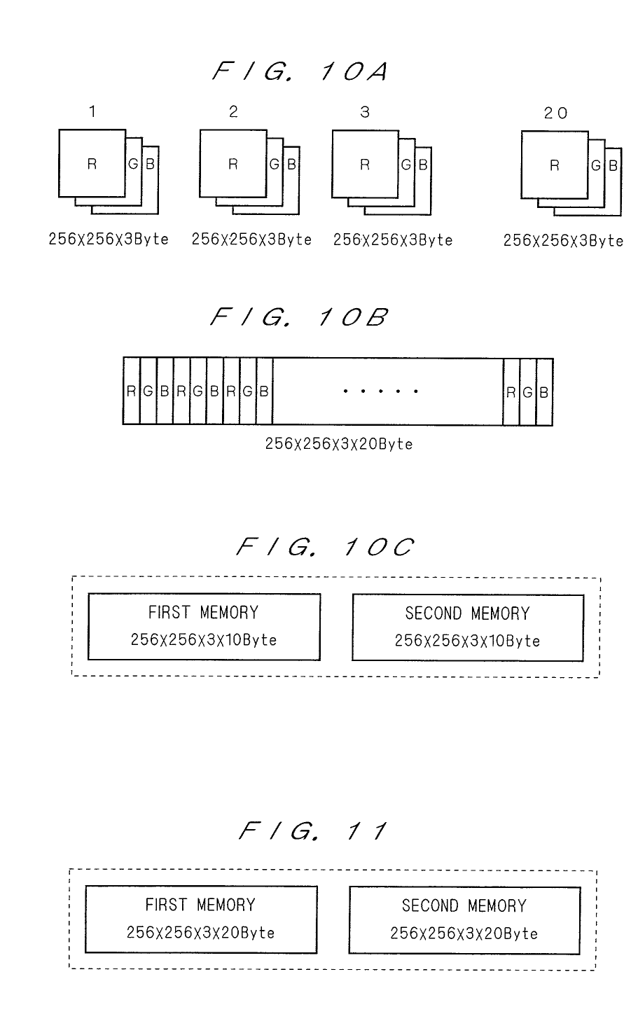

FIGS. 10A, 10B and 10C are drawings that show examples of the construction of the memory. FIG. 10A shows an example in which one memory is used for each image of each of the color components of R, G and B, and in this case, three memories corresponding to R, G and B store two-dimensional image data related to one cross-sectional image. Therefore, in the case of FIG. 10A, although the memory size of each memory is small, at least 60 memories are required so as to store two-dimensional image data corresponding to one scene. Moreover, FIG. 10B shows a case in which one memory is used, and FIG. 10C shows a case in which two memories are used.

When a three-dimensional image to be displayed is a still image, one memory can store two-dimensional image data related to all the groups of cross-sectional images corresponding to one scene as shown in FIG. 10B, and this is successively outputted to the DMD 33 repeatedly to provide a three-dimensional display. However, in the case when a moving image is displayed, the contents of the cross-sectional images to be displayed as one scene change with time in response to the rotation of the screen 38; therefore, the two-dimensional image data inside the memory need to be updated successively. In other words, in the case of dealing with a moving image, the reading (displaying) and writing (updating) operations of the two-dimensional image data have to be carried out simultaneously in parallel with each other. Consequently, the construction of FIG. 10B having only one memory fails to simultaneously carry out the reading operation of the stored two-dimensional image data and writing operation of new two-dimensional image data, resulting in a failure in displaying a moving image.

In contrast, in the cases of FIGS. 10A and 10C where a plurality of memories are installed, when provision is made so that the memory to be read and the memory to be written are successively switched, the reading and writing operations of the two-dimensional image data are carried out in parallel with each other in terms of time, thereby making it possible to deal with a moving image display.

Here, in comparison with the memory constructions of FIG. 10A and FIG. 10C, the construction of FIG. 10A, which has 60 memories, requires a complex device structure and a complex memory controlling operation in successively switching the memory to be read and the memory to be written; in contrast, the construction of FIG. 10C only requires a simple construction and memory controlling operation since switching is simply made alternatively between the two memories with respect to the reading and writing operations. For this reason, in the present preferred embodiment, with respect to a memory construction capable of displaying a three-dimensional moving image of a display subject, FIG. 9 shows one example that uses the memory construction of FIG. 10C.

However, upon adopting the memory construction shown in FIG. 10C, it is necessary to solve a problem with data transfer rates. In the case of the construction of FIG. 10C, the two-dimensional image data of 256×256×3×20 Bytes corresponding to one scene is stored in two memories in a divided manner. In this case, while the two dimensional image data of 256×256×3×10 Bytes, stored in a first memory, is being read and supplied to the DMD 33, the next two dimensional image data of 256×256×3×10 Bytes has to be stored in a second memory. As described earlier, the transfer rate of two-dimensional image data from the host computer 3 or the recording medium 4 is low as compared with the transfer rate at the time of supplying two-dimensional image data from the memory to the DMD 33; consequently, it is more likely to have a case in which while the two-dimensional image data corresponding to ½ scene is being read from one of the memories, the next two-dimensional image data corresponding to ½ scene has not been written in the other memory. In the event of this situation, it becomes impossible to project the latter half of a cross-sectional image while the screen 38 rotates once.

In order to solve this problem, in the present preferred embodiment, upon adopting the memory construction shown in FIG. 10C, the storage capacity of each memory is designed to store at least two-dimensional image data corresponding one scene. For example, as illustrated in FIG. 11, each of the memories is allowed to have a memory size of 256×256×3×20 Bytes so that each memory can store the two-dimensional image data corresponding to one scene. With this arrangement, even in the case when, while two-dimensional image data corresponding to one scene (preceding data group that has been inputted) is being read from one of the memories, the next two-dimensional image data corresponding one scene (succeeding data group to be inputted after the preceding data group) has not been written in the other memory, the same scene as the preceding scene can be displayed again repeatedly. Thus, the cross-sectional images are continuously projected on the screen 38 without being suspended, thereby making it possible to maintain after-image effects.

Therefore, in the present preferred embodiment, each of the memory 63a and memory 63b, shown in FIG. 9, is allowed to have a memory size that stores the two-dimensional image data corresponding to one scene, that is, all the two-dimensional image data of groups of cross-sectional images required for displaying a three-dimensional image of a display subject.

In the explanation of FIG. 9 again, the system controller 64 gives an instruction to the screen controller 72 for controlling the rotative operation of the image rotation compensating mechanism 34 and the operation of the motor 74 in the projection system 51 so as to execute the driving operations. Moreover, the system controller 64 also gives an instruction to the lens controller 77 for controlling the operation of the driving motor 74, not shown, for the lenses 5111b to 5111d in the incident-side lens group 5111 in the double telecentric lens 511. Moreover, the system controller 64 also controls the driver 70 for driving the white light source 41, and manages and controls the interface 66 and the data expander 65 so as to execute transmissions to the DMD controller 62, such as a transmission of the supply state of the two-dimensional image data to the DMD driving section 60.

Moreover, the system controller 64 is designed so that it gives instructions to a character generator 69 so as to display proper characters and symbols on the screen of the liquid crystal display 21, and inputs input information from the operation switch 22 that is detachably attached. More specifically, this gives an instruction thereto so as to display a user setting magnification on the liquid crystal display 21 that is a desired magnification to the actual dimension of a display subject set by the user. In other words, the user set magnification represents the relative size of the three-dimensional image display to the actual dimension.

Furthermore, the operation switch 22 and the three-dimensional image display apparatus 100 are arranged so as to execute infrared communications with each other, and a transmitting and receiving section 75a and a driver 75b used for infrared communications are placed on the three-dimensional image display apparatus 100 side, and a transmitting and receiving section 76a and a driver 76b are placed on the operation switch 22 side.

Here, sound data, contained in the two dimensional image data, is restored by an audio decoder, not shown, installed in the data expander 65, and the audio data obtained here is outputted from the speaker 25 through a D/A converter 68a and an amplifier section 68b. Moreover, a power supply 67 supplies power to the respective parts of the three-dimensional image display apparatus 100, shown in FIG. 9.

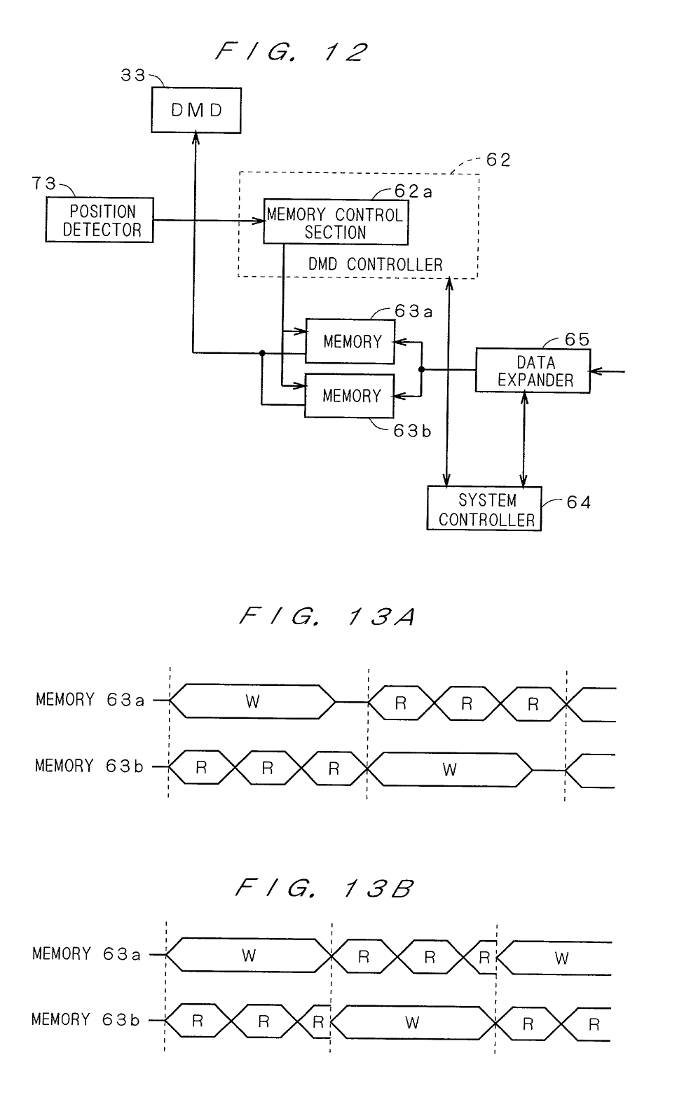

FIG. 12 is a drawing that shows an essential portion of the construction of FIG. 9. As described above, in the present preferred embodiment, the two memories 63a and 63b are installed so as to change the three-dimensional image of a display subject as time elapses to display a moving image of the display subject, and the writing operation on one of the memories and the reading operation from the other memory are carried out in parallel with each other in terms of time. More specifically, the memory control section 62a in the DMD controller 62 functions as a control element for switching the memory to be read from and the memory to be written in so that, in response to the rotation angle of the screen 38 obtained by the position detector 73, the reading operation and the writing operation of the memories 63a and 63b are alternately switched. Here, the memory control section 62a and the two memories 63a and 63b integrally function as a buffer element that serves as a buffer when the group of two-dimensional image data, which collectively represent one scene of a display subject entirely by using a plurality of cross-sectional images, are inputted.

The two-dimensional image data, supplied from the data expander 65, are supplied to both of the memories 63a and 63b; however, only one of the two memories that has received a writing instruction from the memory control section 62a is allowed to write (or update) the two-dimensional image data from the specified addresses successively. On the other hand, the other memory that has received a reading instruction from the memory control section 62a successively outputs the plurality of two-dimensional image data that have stored based upon the instruction from the memory control section 62a, and gives these to the DMD 33.

In order to allow the DMD 33 to generate cross-sectional images based upon the rotation angle obtained from the position detector 73, the memory control section 62a controls the reading operation of the two-dimensional image data by specifying reading addresses on one of the memories 63a (or 63b); thus, the display of the cross-sectional images is controlled. Upon completion of the projection of the group of cross-sectional images corresponding to one scene, the memory control section 62a checks the other memory 63b (or 63a) to see whether or not the writing operation of two-dimensional image data (group of succeeding data) corresponding to the next one scene has been completed. When this has been completed, it switches the memories to be read from and to be written in, and when this has not been completed, it controls one of the memories 63a (or 63b) to be read from so that the same scene is again projected repeatedly by successively reading the two-dimensional image data (preceding data group) corresponding to one scene. In other words, at this time, the memory control section 62a serves as a repeating control element for carrying out the reading operation of the preceding data group repeatedly.

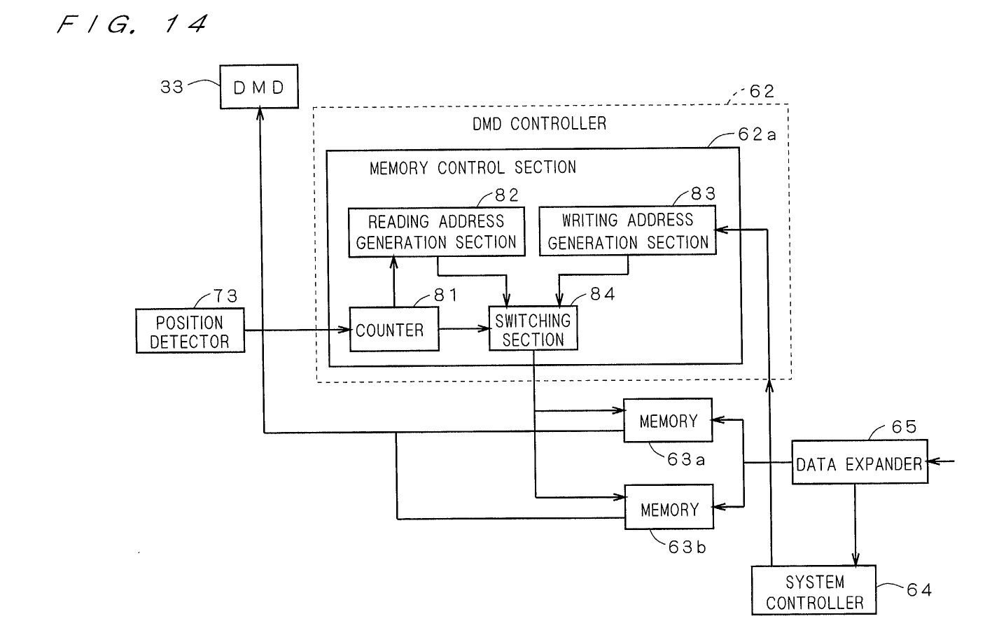

FIGS. 13A and 13B are timing charts that show one example of the operations in the memories 63a and 63b having the above-mentioned arrangement. Here, “W”, given in FIGS. 13A and 13B, represents the writing operation time corresponding to one scene, “R” represents the reading operation time corresponding to one scene. As described above, while the group of two-dimensional image data corresponding to one scene is being written in one of the memories, the reading operation from the other memory is repeatedly carried out; in this case, with respect to the timing operations of the memories 63a and 63b, two patterns as shown in FIGS. 13A and 13B are proposed. In the timing operation of FIG. 13A, the switching of the memories to be written in and to be read from is not made immediately after completion of the writing operation of the two-dimensional image data corresponding to one scene on the memory to be written in; in contrast, immediately after the writing operation of the two-dimensional image data corresponding to one scene on the memory to be read out that is being carried out at that point of time has been all read, the switching is made. On the other hand, in the timing operation of FIG. 13B, immediately after the completion of the writing operation of the two-dimensional image data corresponding to one scene on the memory to be written in, the switching is made between the memories to be written in and to be read from.

Any of these timing operations can be realized by the controlling operation of the memory control section 62a; however, in the case of FIG. 13B, since the switching is made immediately after completion of the writing operation of two-dimensional image data corresponding to one scene on the memory to be written in, one scene of the display subject being displayed at this point of time is interrupted, and the angle of the origin in the display for each scene is offset. Such a disadvantage might not raise any particular problem depending on the shape, etc., of the display subject; however, it is preferable to control so as to provide the timing operation of FIG. 13A since such a disadvantage is preliminarily eliminated.

FIG. 14 is a functional block diagram that more specifically shows the memory control section 62a for carrying out such a control. In other words, the pulse signal synchronizing to the rotation angle obtained from the position detector 73 is counted by a counter 81, and the result thereof is sent to an address generation section 82 and a switching section 84. In the reading address generation section 82, a cross-sectional image suitable for the present position of the screen 38 is specified based upon the result of the count so that a reading address used for reading out the corresponding two-dimensional image data is generated. On the other hand, the writing address generation section 83 generates a writing address for the two-dimensional image data supplied based upon the supplying state of the two-dimensional image data from the data expander 65 transmitted from the system controller 64. These addresses, generated by the reading address generation section 82 and the writing address generation section 83, are directed to the switching section 84, respectively. When it is judged that the projection of the group of cross-sectional images corresponding to one scene has been completed based upon the rotation angle from the counter 81, the switching section 84 checks to see whether or not the writing operation of the two-dimensional image data corresponding to the next one scene has been completed on the other memory. When this has been completed, the switching is made between the memories to be read from and to be written in, and the transmission ends of the reading address and the writing address are switched, and when this has not been completed, no switching operation is carried out.

With the above-mentioned arrangement and controlling operations, it is possible to update the cross-sectional images to be projected onto the screen 38 in response to the rotation of the screen 38, and consequently to display even a moving image of a display subject in a three-dimensional display by using the volume scanning method. Moreover, even in the case when, upon completion of the reading operation of the two-dimensional image data related to the group of cross-sectional images corresponding to one scene from the memory to be read from, the input from the host computer 3, etc., or the expansion process in the data expander 65 has not been completed, and the writing operation (updating operation) of the two-dimensional image data on the other memory has not been completed, it is possible to avoid an interruption of the cross-sectional image to be projected onto the screen 38, and always to maintain a proper three-dimensional display.

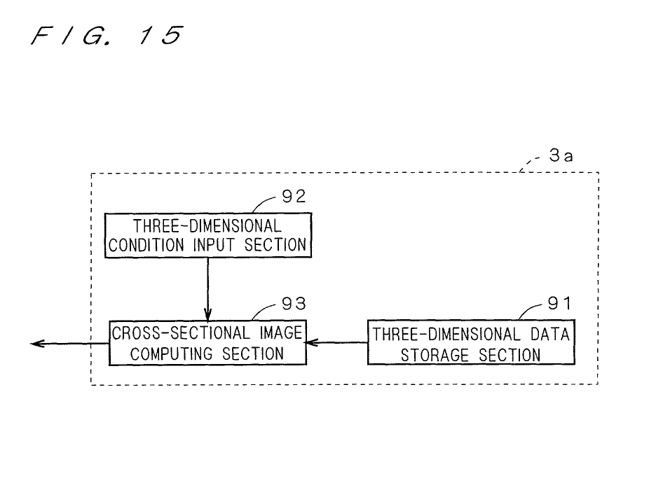

Next, an explanation will be given of the generation of two-dimensional image data related to cross-sectional images. FIG. 15 is a block diagram that shows the functional construction of the host computer 3 of FIG. 9. The CPU 3a of the host computer 3 functions as a three-dimensional storage section 91, a three-dimensional display condition input section 92 and a cross-sectional image computing section 93. Here, from three-dimensional image data of a display subject, two-dimensional image data is obtained every cross-sectional image corresponding to the rotation angle of the screen 38, and the resulting data is supplied to the three-dimensional image display apparatus 100.

The three-dimensional data storage section 91 stores three-dimensional image data of the display subject. Here, the three dimensional image data to be stored is data related to a moving image of the display subject. For example, each of the states of the display subject from the initial state to the final state is stored in the three-dimensional data storage section 91 as one piece of three-dimensional image data; thus, it is possible to store the three-dimensional image data related to the moving image of the display subject.

Moreover, a three-dimensional display condition input section 92 for setting display conditions, etc., as to what size and what state the stored display subject is displayed in is installed, and based upon the three-dimensional image data read from the three-dimensional data storage section 91 and the display conditions given by the three-dimensional display condition input section 92, two-dimensional image data of cross-sectional images obtained by slicing the display subject on a predetermined angle basis is generated by the cross-sectional image computing section 93.

The following description will discuss the three-dimensional image data and the two-dimensional image data in more detail. The three-dimensional image data has a data structure as shown in Table 1.

TABLE 1

Apex coordinates data (unit of mm)
Polygon data
Texture coordinator
Texture data

In other words, the three-dimensional image data is data in which the surface of the display subject is divided into a plurality of polygons, and thus expressed, and consists of coordinates data of each of apexes of polygons, polygon data, texture coordinator and texture data.

In this case, the coordinates data of each of the apexes is represented by three-dimensional coordinates values indicated by the unit of millimeter. The polygon data is data that indicates which apexes of the plurality of apexes form a set of polygon plane. The texture coordinator is data that indicates which polygon plane each of the texture data, which represents the image on each polygon surface (the image to be affixed to each polygon surface), corresponds to.

Moreover, the two-dimensional image data has a data structure as shown in Table 2.

TABLE 2

| | |
|---|---|
| Header portion | • Data file name • Comment |
| | • Image size (longitudinal, lateral, gradation range) |
| | • Dimension data |
| | • Color or monochrome |
| | • Number of images |
| R data | |
| G data | |
| B data | |

In other words, the two-dimensional image data is constituted by a header portion and data of respective color components of R, G and B.

The header portion includes a data file name and a comment that readily identify data, an image size, a dimensional data, data indicating a color image or a monochrome image and data indicating the number of images.

Among these, the image size consists of data indicating the numbers of longitudinal and lateral pixels of the two-dimensional image data as well as data indicating the range of gradation value (the greatest value of gradation) of each of the color components.

Moreover, the dimensional data is data indicating the actual dimension of the display subject in the unit of millimeter.

Furthermore, the RGB color component data is data representing the gradation value of each of the color components R, G and B, and has a data size of the number of pixels×the number of images contained in one frame of cross-sectional image data.

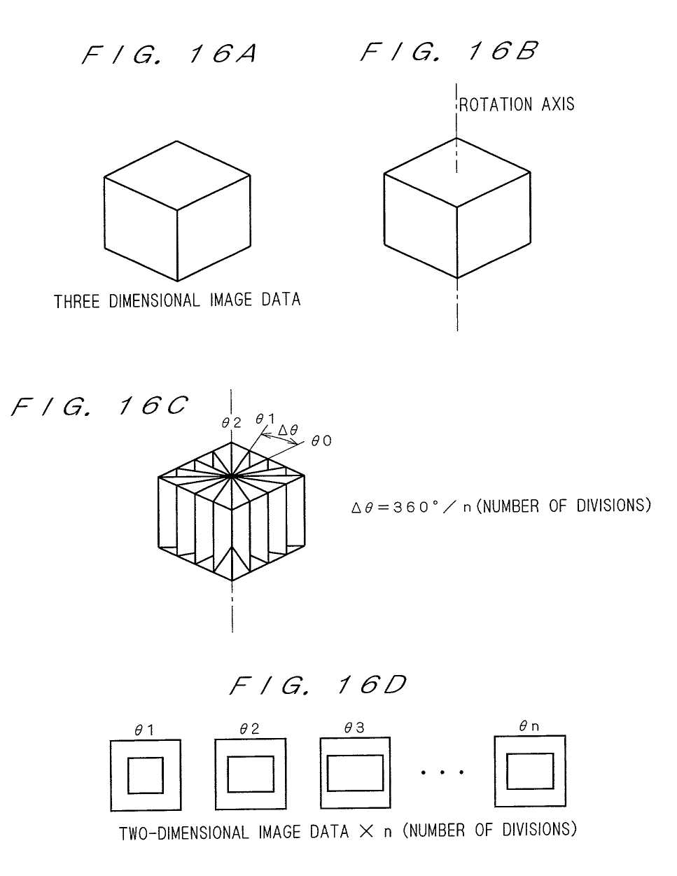

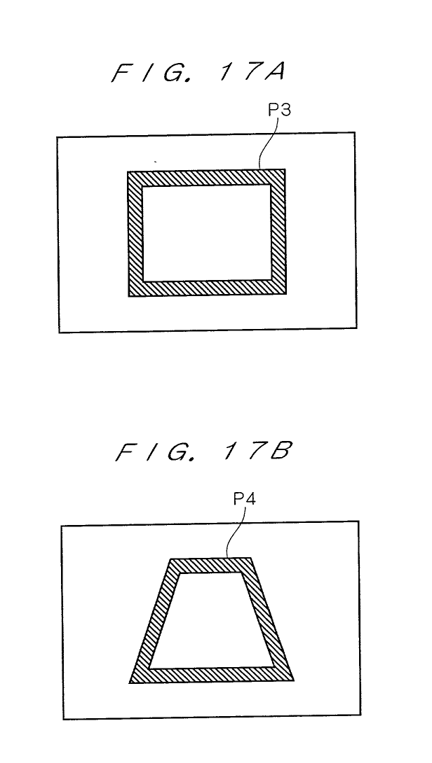

FIGS. 16A, 16B, 16C and 16D are drawings that show conversion processes from three-dimensional image data to two-dimensional image data that are carried out in the cross-sectional image computing section 93. First, with respect to the three-dimensional image data of a display subject as shown in FIG. 16A, the rotation axis serving as the center axis at the time of providing a rotative display is set. This state is shown in FIG. 16B. Further, setting is made as to how many divisions are made in the three-dimensional image data during one rotation so that, as illustrated in FIG. 16C, the display subject is sliced into radial faces virtually every uniform angle in accordance with the number of divisions. The cross-sectional images of the display subject, obtained by this slicing process, are represented as image data so that two-dimensional image data, related to the cross-sectional images of the display subject sliced every predetermined angle as shown in FIG. 16D, is generated.

All the two-dimensional image data of a group of cross-sectional images, required for displaying a three-dimensional image of the display subject while it rotates once as shown in FIG. 16D, is allowed to form two-dimensional image data corresponding to one scene. Based upon the two-dimensional image data corresponding to one scene, a three-dimensional display is provided so that a three-dimensional image representing the display subject in its certain state is projected. Here, in the case of a moving image, the cross-sectional image computing section 93 successively generates a set of two-dimensional image data forming one scene with respect to each of the states of the display subject from the initial state to the last state, and these sets of data are successively supplied to the three-dimensional image display apparatus 100.

The following description will discuss the conversion from the three-dimensional image data to the two-dimensional image data more specifically. First, each of polygon data in the three-dimensional image data of the display subject is sliced into the above-mentioned radial faces, and a crossing line between the radial face and each polygon is found. With respect to the crossing line, since the three-dimensional image data is given as the unit of millimeter, the coordinate values of each point are also obtained as the unit of millimeter.

Next, the resulting crossing line is divided by the number of displayable pixels (the number of longitudinal pixels and the number of lateral pixels since the display face is rectangular) that the DMD 33 has preliminarily stored so that dimensional data representing one side of a pixel in the DMD 33 is obtained. Moreover, the number of longitudinal pixels and the number of lateral pixels in the above-mentioned DMD 33 and the range of gradation values contained in the texture data are collectively represented as image size data.

Moreover, based upon the texture coordinator, RGB color component data of each of the points within the radial face is obtained from the texture data for the polygon in which each crossing line is contained.

Furthermore, the product between the number of the original three-dimensional image data and the number of radial faces in each three-dimensional image data is found as the number of images.

As described above, the three-dimensional image data represented by the unit of length shown in Table 1 is converted to the two-dimensional image data represented on the basis of pixel unit shown in Table 2.

Here, the two-dimensional image data thus generated is subjected to a data compression by a MPEG 2 system, etc., if necessary.

### D. Correction of Project Image

Next, an explanation will be given of the necessity of correction of the projection image. The projection image needs to be corrected because of the following two reasons. First, in the projected cross-sectional image to the screen 38, a distortion occurs in the cross-sectional image due to a difference in the light path length between the upper portion and the lower portion of the screen 38, and this needs to be corrected. Second, in the case when one volume scanning process is completed by rotating the screen 38 by 180°, the projected cross-sectional image needs to be laterally inverted between cases in which the projection surface of the screen 38 is located on the front side to the viewer and in which it is located on the rear side to the viewer.

First, an explanation will be given of the correction of the projection image in the first case. In the three-dimensional image display apparatus 100, as illustrated in FIG. 5, the projection mirror 37 is placed at a position shifted obliquely below the front face of the screen 38 so as not to intervene the viewing field of the viewer at the time of observing the three-dimensional image. Therefore, the light path lengths are different between the upper portion and lower portion of the screen 38, with the result that at the upper portion of the screen 38, the cross-sectional image is projected in a relatively enlarged manner as compared with the lower portion thereof. Since this state results in a distorted three-dimensional image, the difference in scale in the projected image has to be corrected.

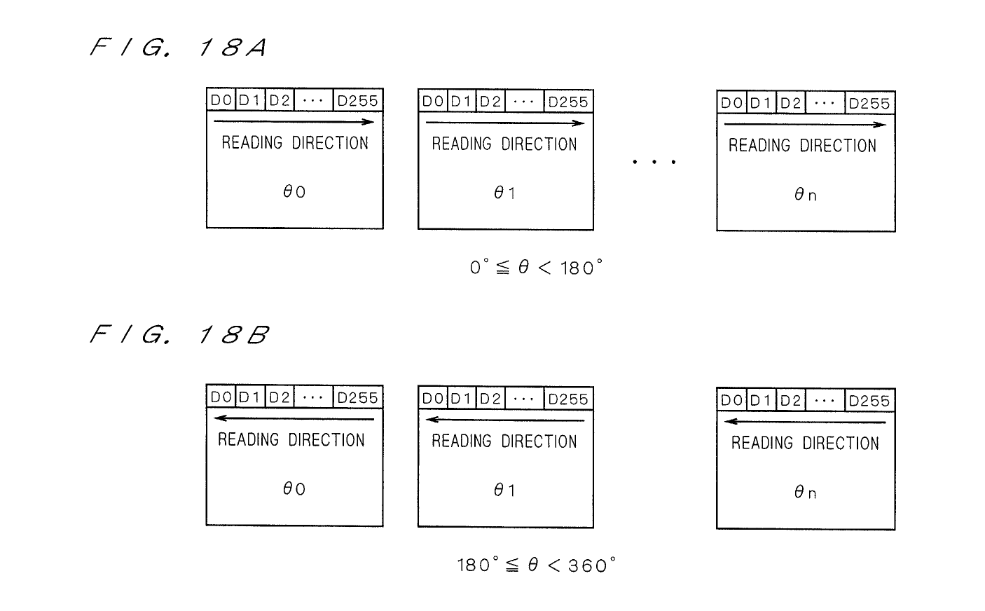

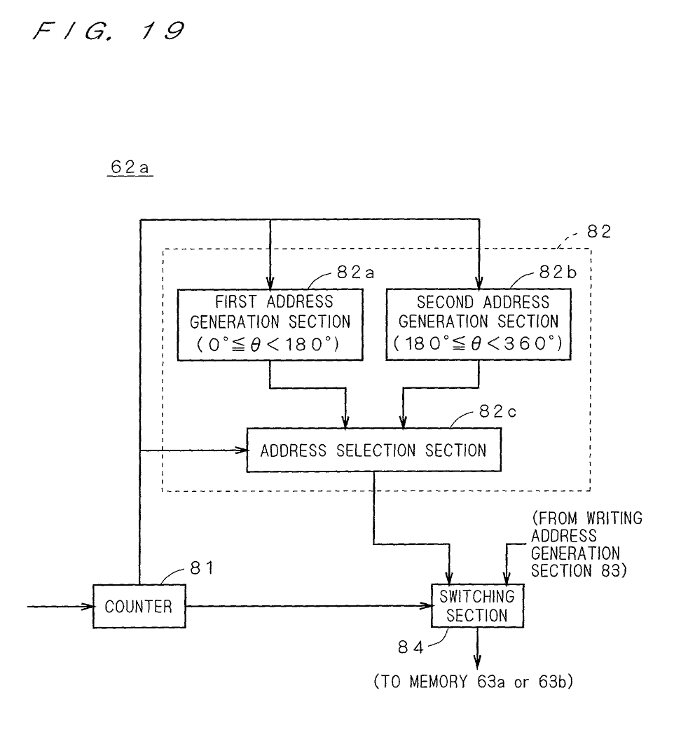

One example of the correction method of the projection image is to preliminarily provide a difference in scale between the upper portion and lower portion of the image with respect to the cross-sectional image generated in the DMD 33. More specifically, in the case when a desired cross-sectional image P3 to be actually projected has a rectangular ring shape as illustrated in FIG. 17A, the two-dimensional original image data to be supplied to the DMD 33 is corrected so as to form an image having a trapezoidal ring shape with a reduced scale in its upper portion as compared with its lower portion as illustrated in FIG. 17B in the cross-sectional image P4 generated in the DMD 33. With respect to a correction element for executing this correction, the host computer 3 may be designed as a correction element so as to reduce the scale in the upper portion as compared with the lower portion upon generating the two-dimensional image data on the host computer 3 side, or the data expander 65 shown in FIG. 9 may be designed as a correction element so as to correct the data upon expansion of the data in the data expander 65. Moreover, a correction element for executing the above-mentioned correction may be placed as a single unit on the rear stage side of the data expander 65. Here, the rate of reduction of the scale is preferably set so as to cancel the rate of the enlargement at the time of projection to the screen 38; therefore, it is preferable to place the correction element on the three-dimensional image display apparatus 100 side.

Moreover, in another correction method for the projection image, for example, a lens system having an asymmetric refraction property with respect to the light axis (a lens system having a smaller magnification on the upper side with a smaller magnification on the lower side) may be placed in the projection optical system. In this case, such a lens system is placed between the projection mirror 36 and the projection mirror 37, or between the projection mirror 37 and the screen 38, or between the DMD 33 and the image rotation compensating mechanism.

Furthermore, another method may be adopted in which a curved surface mirror having a plurality of curvatures for reducing the image with respect to light to be projected on the upper side of either of the projection mirror 36 and the projection mirror 37 and for enlarging the image with respect to light to be projected on the lower side thereof may be adopted. Moreover, curved face mirrors may be adopted as both of the projection mirrors 36 and 37 so that at the time when light is finally projected on the screen 38, the image is reduced with respect to the light projected on the upper side with the image being enlarged with respect to the light projected on the lower side.

Next, an explanation will be given of the correction of the projection image in the second case. In the case when all two-dimensional image data of the group of the cross-sectional images to be projected upon rotation of the screen 38 with 360° is stored in the memories 63a and 63b with the rotation of the screen 38 with 360° being set as the volume scanning process at one time, it is possible to carry out a proper projection of the cross-sectional image in both of the cases in which the projection face of the screen 38 is located on the front side with respect to the viewer and in which it is located on the rear side with respect to the viewer.

However, in the case when all two-dimensional image data of the group of the cross-sectional images to be projected upon rotation of the screen 38 with 180° is stored in the memories 63a and 63b with the rotation of the screen 38 with 180° being set as the volume scanning process at one time, upon projecting a three-dimensional image with an asymmetric rotation shape onto the screen 38, it is necessary to laterally invert the cross-sectional images depending on cases in which the projection surface is located on the front face side and in which it is located on the rear face side. This is because, for example, in an attempt to display a three-dimensional image of a coffee cup as a display subject, when the lateral inversion is not carried out, two handle portions will be displayed in the three-dimensional display image of the coffee cup at the symmetric positions with respect to the rotation axis, in spite of the fact that it has one handle.

As one example for carrying out such a lateral inversion, a method is proposed in which reading addresses of the memories 63a and 63b used when the two-dimensional image data is supplied from the memories 63a and 63b to the DMD 33 are switched in response to the rotation angle of the screen 38. In this method, each time the screen 38 makes a rotation of 180°, the data reading order in the horizontal direction in the cross-sectional image is simply switched so as to invert the cross-sectional image; thus, no alternation is required in the vertical direction in the cross-sectional image.

For example, in the case when the size of the cross-sectional image is given as 256 pixels (horizontal direction)×256 pixels (vertical direction) as shown in FIG. 8, the horizontal addresses used upon reading the two-dimensional image data from each of the memories 63a and 63b include 8 bits, and it is possible to specify pixels from 0-numbered one to 255-numbered one in the horizontal direction. Then, the memory control section 62a, shown in FIG. 12, switches the reading order of the two-dimensional image data in the horizontal direction to be given from the memories 63a and 63b to the DMD 33, in response to the rotation angle of the screen 38 obtained from the position detector 73.

FIGS. 18A and 18B are drawings that show the order of the reading processes from the memories 63a and 63b in response to the rotation angle θ of the screen 38. As shown in FIGS. 18A and 18B, two-dimensional image data corresponding to n frames is stored in the memories 63a and 63b as the group of cross-sectional images to be projected upon rotation of the screen 38 with 180°. Here, as illustrated in FIG. 18A, in the case when the rotation angle θ of the screen 38 is in the range of 0°≦θ<180°, with respect to the two-dimensional image data of n frames, image data D0, D1, D2, . . . , D255 are successively read rightwards in the horizontal direction pixel by pixel, and supplied to the DMD 33. In contrast, as illustrated in FIG. 18B, in the case when the rotation angle θ of the screen 38 is in the range of 180°≦θ<360°, with respect to the two-dimensional image data of n frames, image data D255, D254, D253, . . . , D0 are successively read leftwards in the horizontal direction pixel by pixel, and supplied to the DMD 33.

In other words, in the case when the rotation angle θ of the screen 38 is in the range of 0°≦θ<180°, the respective image data of the two-dimensional image data are successively read rightwards in the horizontal direction orthogonal to the rotation axis Z in the first reading mode, while, in the case when the rotation angle θ of the screen 38 is in the range of 180°≦θ<360°, the respective image data of the two-dimensional image data are successively read leftwards in the horizontal direction orthogonal to the rotation axis Z in the second reading mode.

FIG. 19 shows one example of a control mechanism for switching the order of the reading processes in this manner. FIG. 19 shows a detailed structure of a reading address generation section 82 shown in FIG. 14. As illustrated in FIG. 19, the reading address generation section 82 is provided with a first address generation section 82a, a second address generation section 82b and an address selection section 82c. The first address generation section 82a generates reading addresses at the time when the rotation angle θ of the screen 38 is in the range of 0°≦θ<180°, and the second address generation section 82b generates reading addresses at the time when the rotation angle θ of the screen 38 is in the range of 180°≦θ<360° (that is, the reading addresses set in the order reversed to the reading order in the horizontal direction generated in the first address generation section 82a). Both of the first address generation section 82a and the second address generation section 82b specify a cross-sectional image suitable for the current position of the screen 38 based upon the count result obtained from the counter 81 so that it always generates a reading address for reading the resulting two-dimensional image data.

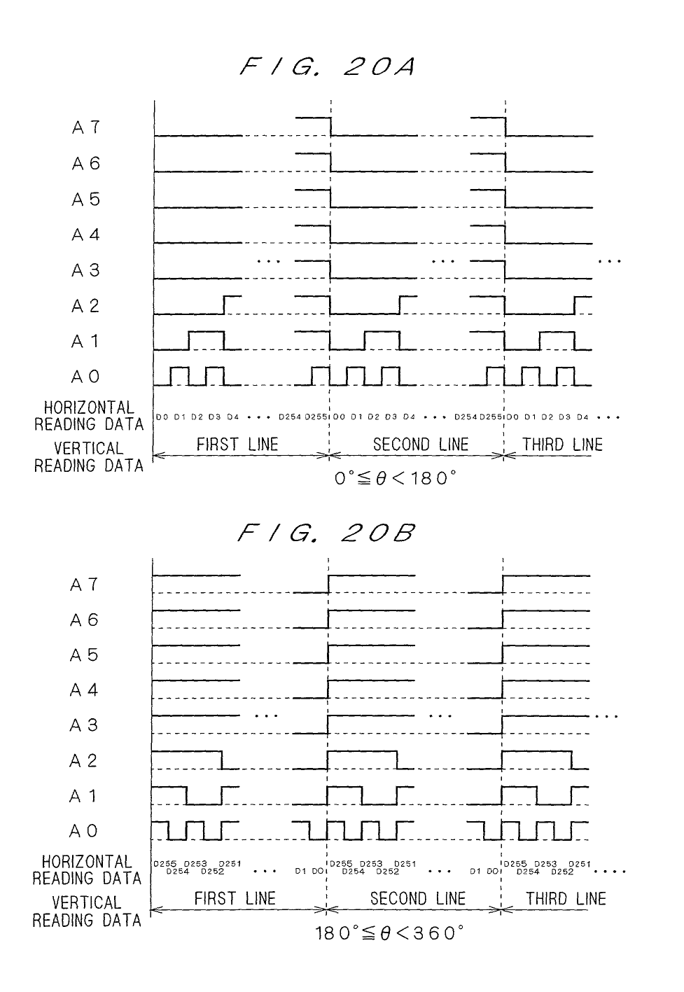

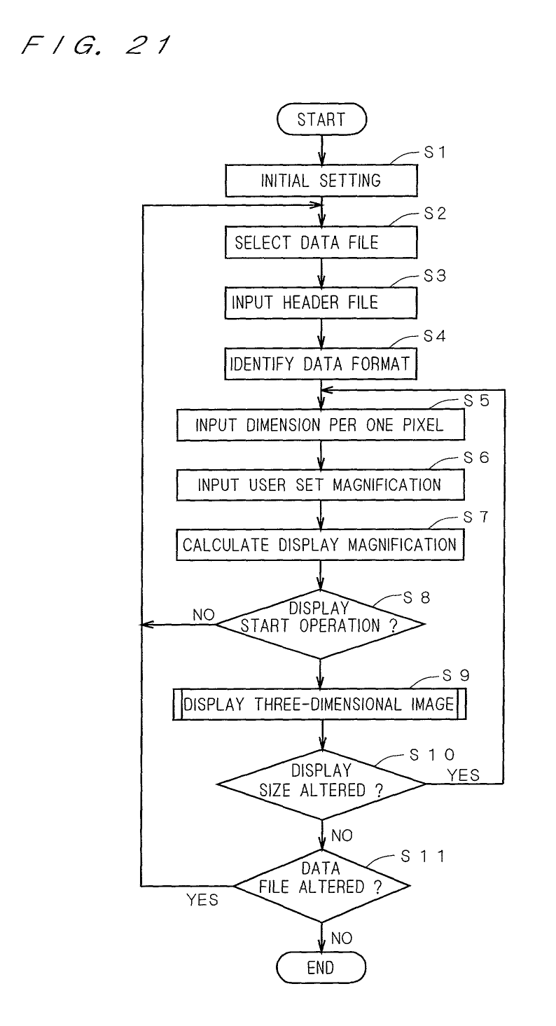

FIGS. 20A and 20B are drawings that show one example of horizontal address signals of 8 bits generated in the address generation sections 82a and 82b. FIG. 20A shows an address signal generated in the first address generation section 82a, and FIG. 20B shows an address signal generated in the second address generation section 82b. Here, FIGS. 20A and 20B show signals A0 to A7 in the unit of bit.

As illustrated in FIGS. 20A and 20B, depending on cases in which the rotation angle o of the screen 38 is in the range of 0°≦θ<180° and in which the rotation angle θ of the screen 38 is in the range of 180°≦θ<360°, the respective bit signals A0 to A7 have a level-inverted relationship from each other. As a result, in the case of the range of 0°≦<180°, the data is read out pixel by pixel in the order as shown in FIG. 18A, and in the case of the range of 180°≦θ<360°, the data is read out pixel by pixel in the order as shown in FIG. 18B. As illustrated in FIGS. 20A and 20B, with respect to the two-dimensional image data of second line and thereafter, the reading address is set in the same reading order (direction) as the first line.

In this manner, the reading addresses, generated in both of the first address generation section 82a and the second address generation section 82b, are directed to the address selection section 82c. The address selection section 82c checks to see whether the rotation angle θ obtained from the counter 81 is in the range of 0°≦θ<180° or in the range of 180°≦θ<360°, and in the case of the range of 0°≦θ<180°, the address signals (see FIG. 20A) generated in the first address generation section 82a are supplied to the switching section 84, while in the case of the range of 180°≦θ<360°, the address signals (see FIG. 20B) generated in the second address generation section 82b are supplied to the switching section 84.

With the arrangement as described above, upon reading the two-dimensional image data from the memory 63a or 63b, the order of reading processes in the horizontal direction of the cross-sectional images can be inverted (switched) in response to the rotation angle of the screen 38. Consequently, the two-dimensional image data given to the DMD 33 is provided as data that is laterally inverted every rotation of the screen 38 with 180°, and the cross-sectional image projected on the screen 38 is also laterally inverted every rotation of 180°. Thus, the lateral inversion of the cross-sectional image is achieved in the case when the rotation of the screen 38 with 180° is set as the volume scanning process of one time, thereby making it possible to desirably carry out the correction of the projection image.

### E. Outline of Processing Sequence in the Three-dimensional Image Display Apparatus 100

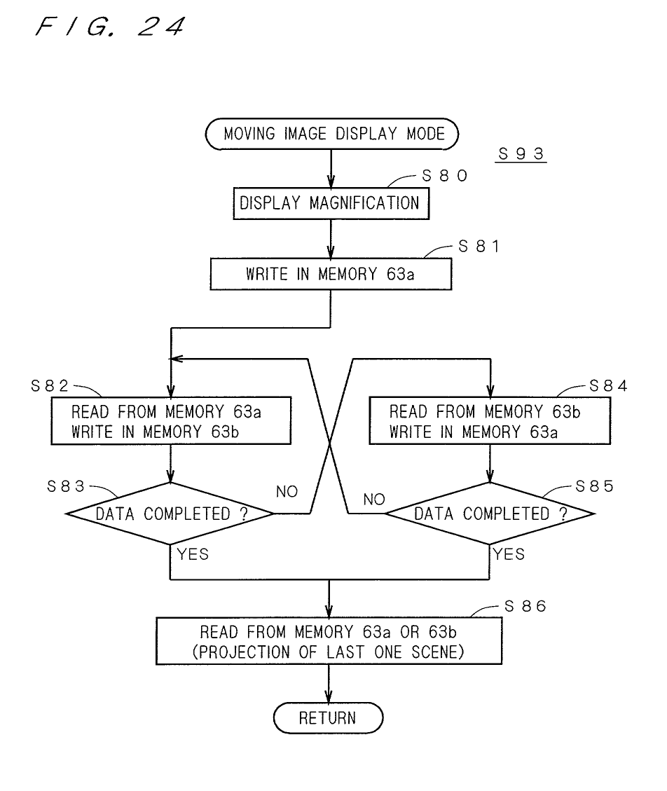

Next, an explanation will be given of the outline of the processing sequence actually carried out upon displaying a three-dimensional image in the three-dimensional image display apparatus 100. FIGS. 21 to 24 are flow charts that show the processing sequence, and, more specifically, FIG. 23 is a flow chart related to the display process in the case of providing a three-dimensional display for a still image, and FIG. 24 is a flow chart related to the display process in the case of providing a three-dimensional display for a moving image.

In the flow chart of FIG. 21, first, an initial setting process is carried out (step S1). The contents of this initial setting process include, for example, an initializing process for parameters related to the stability of the power supply and various processing conditions.

Then, the sequence proceeds to step S2 where the viewer (operator) carries out inputs for selecting data files through the operation switches 22. For example, in the construction of FIG. 9, in the case when the two-dimensional image data is stored in a recording medium 4, file names, etc., related to the two-dimensional image data are displayed on the liquid crystal display 21, and the viewer selects desired data files while confirming the contents of the display on the liquid crystal display 21. Moreover, in the case when the two-dimensional image data is stored on the host computer 3 side, data communications are carried out between the three-dimensional image display apparatus 100 and the host computer 3 under instructions from the system controller 64 so that file names, etc. related to the two-dimensional image data stored in the host computer 3 are displayed on the liquid crystal display 21. As a result, the viewer is allowed to select desired data files while visually confirming the contents of the display on the liquid crystal display 21.

Upon completion of the selection of the data file, the sequence proceeds to step S3 where a header file is inputted with respect to the data file selected at step S2. In other words, the system controller 64 acquires the header file from the recording medium 4 or the host computer 3. The header file includes various pieces of information required for displaying a three-dimensional display, such as information of the size of the cross-sectional image, that is, information as to how many pixels in the horizontal and vertical directions constitute the cross-sectional image, the number of the cross-sectional images constituting one scene, information as to the volume scanning process of one time, that is, the rotation of 180° or the rotation of 360°, the number of scenes in the case of a moving image, and a data format indicating whether the two-dimensional image data is of the still image format or the moving image format.

Then, the sequence proceeds to step S4 where the system controller 64 identifies the data format from the header file so as to recognize whether the three-dimensional image to be displayed is a still image or a moving image. Then, the above-mentioned various pieces of information are transmitted to various parts, thereby entering a preparing stage for a three-dimensional display.

Next, dimensional data indicating the dimension of one pixel is read from the two-dimensional image data, and inputted (step S5).

Next, the user (viewer) inputs the aforementioned user set magnification (step S6). Here, in the case when the equal size (display based upon the actual size) is desired, a magnification of 1 is inputted as the user set magnification.

Next, the system controller 64 calculates the display magnification (step S7). In other words, the display magnification is calculated based upon the actual size magnification for actually providing a three-dimensional display using the dimension indicated by the dimensional data and the user set magnification.

More specifically, the dimensional data indicating the length of one side of each pixel in the two-dimensional image data is divided by the pixel pitch on the screen at the time of equal magnification that has been preliminarily calculated, that is, the length of one side of each pixel on the screen corresponding to one pixel in the DMD 33, and the resulting quotient is set as the actual dimensional magnification. In other words, the actual dimensional magnification is a magnification used at the time when a three-dimensional image is projected in the actual dimension.

Then, at the time when a three-dimensional display is actually provided, the display magnification is found from the following equation by using the actual dimensional magnification and the user set magnification.

Display magnification=Actual dimensional magnification×User set magnification

Further, by using the resulting display magnification, the incident side lens group 5111 that is a zoom optical system in the double telecentric lens 511 is driven.

Here, in the case when the three-dimensional image of the display subject is not set within the displayable range of the screen 38, the cross-sectional image data located outside the screen 38 is preliminarily eliminated.

Thereafter, the sequence enters an input stand-by state from the operational switch 22 (step S8), and upon receipt of a display starting instruction from the viewer (that is, the operation of the start button 222), the sequence proceeds to step S9, and if no display staring instruction is given, the sequence returns to step S2. Here, in the case when the viewer inputs a display starting instruction for a still image, the viewer also sets the display time of the still image.

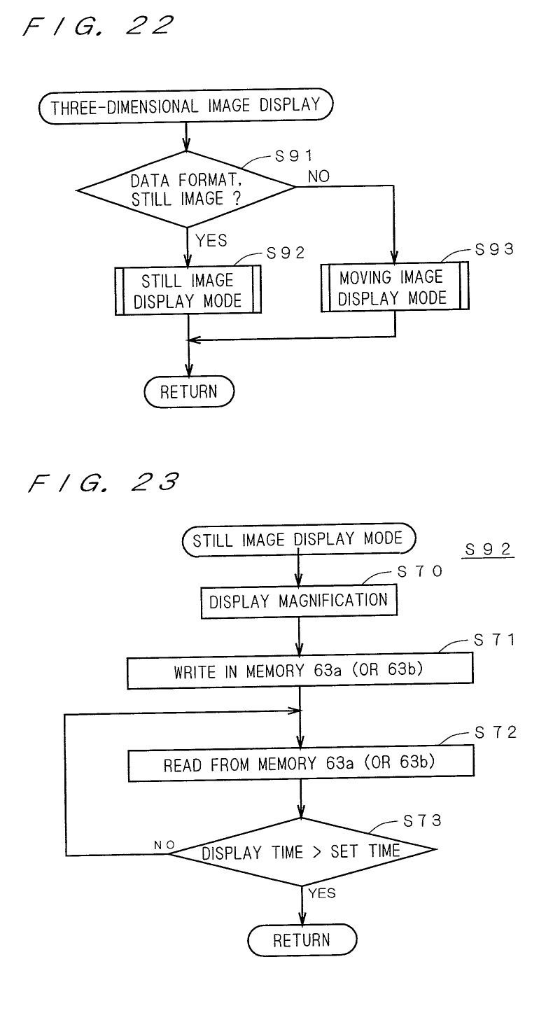

FIG. 22 is a detailed flow chart indicating the three-dimensional image display. At step S9, a judgment is made as to whether or not the data format recognized at step S4 is related to a still image or a moving image (step S91), and in the case of a still image, the sequence proceeds to step S92, while in the case of a moving image, the sequence proceeds to step S93.

As illustrated in FIG. 23, in the case when the still image display mode (step S92) is on, first, a magnification display is given on the liquid crystal display 21 under the control of the system controller 64, that is, a user set magnification is displayed (step S70). Moreover, an input of the two-dimensional image data from the recording media 4 or the host computer 3 is started under the control of the system controller 64. Consequently, the two-dimensional image data with respect to the still image is successively supplied to the data expander 65 through the interface 66 for each of the cross-sectional images. Thus, while the expanding process is carried out in the data expander 65, the expanded two-dimensional image data is written in one of the memories 63a (or 63b) of the two memories 63a and 63b (step S71). At this time, the memory control section 62a in the DMD controller 60 specifies one of the memories 63a (or 63b), and successively specifies writing addresses with respect to this memory. Upon completion of the writing process for the two-dimensional image data related to all the cross-sectional images for displaying the still image, the sequence proceeds to step S72.

At step S72, the two-dimensional image data, written in one of the memories 63a (or 63b), is successively read out, and the two-dimensional image data thus read is supplied to the DMD33. Consequently, a cross-sectional image corresponding to the two-dimensional image data given to the DMD 33 is projected on the rotating screen 38.

At this time, the system controller 64 drives the incident side lens group 5111 of the double telecentric lens 511 through the lens controller in accordance with the display magnification obtained at the step S7, thereby providing a three-dimensional image display in accordance with the display magnification.

When all the two-dimensional image data, stored in the memory 63a (or 63b), has been sequentially supplied to the DMD 33, the sequence proceeds to step S73 where a judgment is made as to whether or not the display time has exceeded a set period of time, and in the case when it has not reached the set period of time, the sequence returns to step S72 so as to again carry out the display of the same cross-sectional image. In contrast, in the case when it has exceeded the set period of time, the process related to the display of the still image is completed.

Here, in the case when the process of the step S72 is repeatedly carried out with the rotation of the screen with 180° being set as the volume scanning process of one time, each time the step S72 is carried out, the above-mentioned reading addresses that allow the lateral inversion of the cross-sectional image to take place are generated. Thus, the correction of the projection image in the still image display is desirably carried out.

Next, as illustrated in FIG. 24, an explanation will be given of a case in which the sequence proceeds to the moving image display mode (step S93). In the case of the moving image display mode (step S93) also, an input of the two-dimensional image data from the recording medium 4 or the host computer 3 is started under the control of the system controller 64. Consequently, the two-dimensional image data with respect to a moving image is successively supplied to the data expander 65 through the interface 66 for each of the cross-sectional images. Here, since the moving image is equivalent to a case in which a plurality of two-dimensional image data are collected for each still image, the data input is not completed immediately, even when the input of the two-dimensional image data has been started. For this reason, while the data input from the recording media 4 and the host computer 3 is being carried out, a three-dimensional display is executed with respect to the moving image.

The data expander 65 successively carries out an expanding process on the two-dimensional image data inputted through the interface 66, and the resulting two-dimensional image data is successively outputted to the memories 63a and 63b.

First, a magnification display, that is, a display of the user set magnification (step S80), is carried out on the liquid crystal display 21 under the control given by the system controller 64. In step S81, the memory control section 62a of the DMD controller 60 sets one of the memories 63a as a writing subject, and specifies writing addresses with respect to this memory 63a. Consequently, the two-dimensional image data corresponding to the first one scene is successively written in the memory 63a. Then, upon completion of the writing process of the two-dimensional image data corresponding to the one scene, the sequence proceeds to step S82.

At step S82, in order to supply the two-dimensional image data written in the memory 63a to the DMD 33, the memory control section 62a sets the memory 63a as a reading subject, and also sets the other memory 63b as a writing subject. Consequently, the two-dimensional image data corresponding to the first one scene is supplied to the DMD 33, and projected onto the rotating screen 38, while the two-dimensional image data corresponding to the next one scene obtained from the data expander 65 is successively written in the memory 63b.

Here, at this time also, the system controller 64 drives the incident side lens group 5111 of the double telecentric lens 511 through the lens controller in accordance with the display magnification obtained at the step S7, thereby providing a three-dimensional image display in accordance with its display magnification.

In this step S82 also, in the case when, upon completion of the sequential reading process of the two-dimensional image data stored in the memory 63a, the writing process of the next one scene with respect to the memory 63b has not been completed, the reading process is again repeated from the memory 63a so that the same cross-sectional images as those of the previous time are projected onto the screen 38. In contrast, in the case when, upon completion of the sequential reading process of the two-dimensional image data stored in the memory 63a, the writing process corresponding to the next one scene with respect to the memory 63b has been completed, the sequence proceeds to step S83.

Then, at step S83, a judgment is made as to whether or not the two-dimensional image data to be supplied from the data expander 65 to the memories 63a and 63b has been finished. In other words, a judgment is made as to whether or not the two-dimensional image data corresponding to all the scenes used for displaying a moving image has been stored in the memories 63a and 63b. Then, in the case when the two-dimensional image data to be supplied from the data expander 65 to the memories 63a and 63b still continues, since the next scene further exists, the judgment is given as “NO” at step S83, and the sequence proceeds to step S84. In contrast, in the case when the two-dimensional image data to be supplied to the memories 63a and 63b no longer exists, since the two-dimensional image data that has been written in the memory 63b at step S82 forms the last scene, the sequence proceeds to step S86 so as to display the last scene.

At step S84, the memory control section 62a sets the memory 63b as a reading subject in order to supply the two-dimensional image data written in the memory 63b to the DMD 33, and also sets the other memory 63a as a writing subject (updating subject). As a result, the two-dimensional image data corresponding to one scene succeeding to the one scene displayed at step S82 is supplied to the DMD 33, and projected onto the rotating screen 38, and two-dimensional image data corresponding to the next one scene obtained from the data expander 65 is successively written in the memory 63a. Here, at this step S84 also, in the case when, upon completion of the sequential reading process of the two-dimensional image data stored in the memory 63b, the writing process corresponding to the next one scene with respect to the memory 63a has not been completed, the reading process is again repeated from the memory 63b, thereby projecting the same cross-sectional images as those of the previous time onto the screen 38. In contrast, in the case when, upon completion of the sequential reading process of the two-dimensional image data stored in the memory 63b, the writing process corresponding to the next one scene with respect to the memory 63a has not been completed, the sequence proceeds to step S85.

Then, at step S85, a judgment is made in the same manner as the step S83. Therefore, in the case when the two-dimensional image data to be supplied to the memories 63a and 63b from the data expander 65 further continues, since the next scene further exists, the judgment is made as “NO” at the step S85, and the sequence proceeds to step S82, and in the case when the two-dimensional image data to be supplied to the memories 63a and 63b no longer exist, since the two-dimensional image data that has been written in the memory 63a at step S85 forms the last scene, the sequence proceeds to step S86 to display the last scene.

Here, it is clearly known from the contents that have already been explained that, at the steps S82 and S84, the writing process of the two-dimensional image data to one of the memories and the reading process of the two-dimensional image data to the other memory are simultaneously carried out in parallel with each other.

At step S86, in order to project the last one scene onto the screen 38, the two-dimensional image data is read from one of the memories 63a or 63b, and this is supplied to the DMD 33.

In this manner, the moving image is displayed, and when, upon reading the two-dimensional image data from the memory 63a or the memory 63b at the steps S82, S84 and S86, the cross-sectional image to be projected onto the screen 38 needs to be laterally inverted, the switching process of the reading addresses is carried out so as to change the reading direction in the horizontal direction as described earlier.

Next, an inquiry is given as to whether or not the display size is changed (step S10), and in the case when the change of the display size is instructed, the sequence returns to step S5. In contrast, in the case of no change in the display size, the sequence proceeds to the next step.

Next, an inquiry is given as to whether or not the data file is changed (step S11), and in the case when the change of the data file is instructed, the sequence returns to step S2. In contrast, in the case of no change in the data file, the process is completed.

By carrying out the above-mentioned sequence of processes, not only the still image, but also the moving image, can be three-dimensionally displayed in the actual dimension or in the user set magnification in comparison with the actual dimension. Moreover, since the user set magnification is displayed on the liquid crystal display 21, this apparatus makes it possible to confirm the actual size of the display subject.

Moreover, the magnification, set by the incident side lens group 5111 (optical variable magnification element) of the double telecentric lens 511, is controlled based upon the dimensional data so as to allow the three-dimensional image displayed on the screen 38 to have virtually the actual size of the display subject; therefore, it is possible to provide a superior three-dimensional image display with high quality, as compared with the magnification process that is made by changing the number of pixels.

### 2. Second Preferred Embodiment

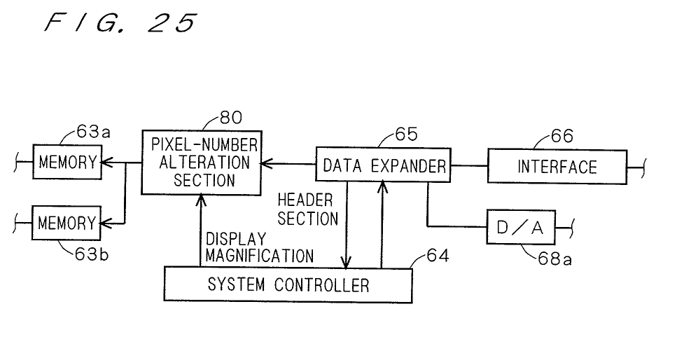

FIG. 25 is a drawing that shows an essential part of a three-dimensional image display system in accordance with a second preferred embodiment. In this three-dimensional image display system, although no zoom optical system (not shown) is installed in the double telecentric lens 511, a pixel-number alteration section 80 for altering the number of pixels with respect to the image data expanded by the data expander is installed. This pixel-number alteration section 80 carries out a resolution converting process, such as a known interpolating or thinning process, on the resulting two-dimensional image data so as to provide a proper corresponding display magnification, under control of the system controller 64; thus, it is possible to carry out a variable magnification process.

For example, in the case when the display magnification is set to 2 times, the interpolating process is carried out so as to double the number of pixels in the two-dimensional image data, and, in contrast, in the case when the display magnification is set to ½, the thinning process is carried out so as to reduce the number of the pixels to half in the two-dimensional image data.

In this manner, the three-dimensional image display apparatus in accordance with the second preferred embodiment, it is possible to carry out a variable magnification process without the need of a zoom optical system.

In accordance with the above-mentioned arrangement, the sequence of processes carried out for displaying a three-dimensional image in the second preferred embodiment is virtually the same as those of FIGS. 21 to 24; and it is only different in that, instead of the zoom optical system for carrying out the variable magnification process, the number of the pixels included in the respective two-dimensional image data in the groups of two-dimensional image data is altered, that is, the resolution thereof is converted, so as to provide the actual dimension (equal size) or the user set magnification of a display subject.

The other arrangements are the same as those of the first preferred embodiment.

As described above, in accordance with the second preferred embodiment, since the pixel-number alteration section 80, which alters the number of pixels contained in the respective two-dimensional image data in the groups of two-dimensional data is changed so as to allow the three-dimensional image displayed on the screen to have the actual dimension or the user set magnification of the display subject, is installed; therefore, it is possible to eliminate the need of a zoom optical system that is more expensive than the pixel-number alteration section 80, and consequently to reduce the manufacturing costs to provide an inexpensive apparatus.

### 3. Modified Example

In the above-mentioned preferred embodiments, examples of a three-dimensional image display apparatus, a three-dimensional image display system and a three-dimensional image display-use data file have been shown; however, the present invention is not intended to be limited by these.

Here, the DMD 33 has been exemplified as an image generation element for generating cross-sectional images to be projected onto the screen 38 based upon the two-dimensional image data given from the memory forming a reading subject; however, elements other than DMD 33 may be used.

Moreover, the above explanations have been given of a structural example in which cross-sectional images are projected on a screen that rotates centered on a predetermined rotation axis Z so that a three-dimensional image of a display subject is displayed; however, the present invention is not limited by this example, and a volume scanning process may be carried out in a straight progressing manner in a direction vertical to the projection surface of the screen. In other words, any screen is used as long as it periodically carries out a scanning process within a predetermined three-dimensional space.

Moreover, in the above-mentioned first preferred embodiment, the zoom optical system in the double telecentric lens 511 is used for altering the magnification of a three-dimensional display, and in the second preferred embodiment, the number of pixels in the image data is altered so as to alter the magnification of a three-dimensional display; however, both of the alteration element of the double telecentric lens 511 and the pixel-number alteration section 80 may be provided. Thus, either of the variable magnification methods may be used depending on cases, or both of the variable magnification methods may be used in combination. In particular, in the case when both of the magnification methods are used, the display size is determined based upon the magnification β1 of the alteration of the number of pixels and the magnification β2 of the zoom optical system. That is, the following equation holds:

Display size=Number of pixels of two-dimensional image data×β1×β2

Here, when the variable magnification process is actually carried out in accordance with the dimensional data, the variable magnification process by the zoom optical system is preferentially carried out, and in the case when, even if the variation magnification by the zoom optical system has reached its limitation, the required magnification is not obtained, the variable magnification by using the alteration of the number of pixels is additionally carried out. This is because the variable magnification using the zoom optical system provides better image quality than the variable magnification by the alteration of the number of pixels.

While the invention has been shown and described in detail, the foregoing description is in all aspects illustrative and not restrictive. It is therefore understood that numerous other modifications and variations can be devised without departing from the scope of the invention.

What is claimed is:

1. A three-dimensional image display apparatus comprising:
a screen for periodically shifting within a predetermined three-dimensional space;
image data acquiring section for acquiring a group of two-dimensional image data that collectively represents said display subject by using a plurality of cross-sectional images;
dimension acquiring section for acquiring dimensional data that represents an actual dimension of said display subject that is associated with said group of two-dimensional image data;
cross-sectional image generation section for successively generating said plurality of cross-sectional images based upon said group of two-dimensional image data;
projection section for projecting said cross-sectional images generated by said cross-sectional image generation section on said screen;
optical variable magnification section for carrying out a variable optical magnification on said cross-sectional images between said display section and said projection section; and
variable magnification control section for controlling said magnification set by said optical variable magnification section so as to allow a three-dimensional image displayed on said screen to virtually have an actual dimension of said display subject.

2. A three-dimensional image display apparatus comprising:
a screen for periodically shifting within a predetermined three-dimensional space;
image data acquiring section for acquiring a group of two-dimensional image data that collectively represents said display subject by using a plurality of cross-sectional images;
dimension acquiring section for acquiring dimensional data that is associated with said group of two-dimensional image data;
cross-sectional image display section for successively displaying said plurality of cross-sectional images based upon said group of two-dimensional image data;
projection section for projecting said cross-sectional images generated by said cross-sectional image generation section on said screen; and
pixel-number alteration section for altering the number of pixels contained in respective two-dimensional image data in said group of two dimensional image data so as to allow a three-dimensional image displayed on said screen to have an actual dimension of said display subject.

3. A three-dimensional image display method comprising the steps of:
receiving three-dimensional image data corresponding to a three-dimensional subject and size data relating to a size of said three-dimensional subject;
correcting said three-dimensional image data so as to change a size of a three-dimensional image to be projected in accordance with said size data; and
projecting said three-dimensional image based upon said three-dimensional image data that has been corrected.

4. The three-dimensional image display method according to claim 3, wherein said size data is length data related to pixel pitches.

5. The three-dimensional image display method according to claim 3, wherein one pixel pitch at a light source has a known length when said pixel pitch is projected on said screen.

6. The three-dimensional image display method according to claim 3, wherein said correction of three-dimensional data is carried out by thinning or interpolating said three-dimensional image data based upon a length of one pixel pitch at a light source measured when said one pixel pitch is projected on said screen, and said size data.

7. A three-dimensional image display apparatus comprising:
a receiving section for receiving three-dimensional image data corresponding to a three-dimensional subject and size data related to a size of said three-dimensional subject;
a light source for emitting light based upon said three-dimensional image data that has been received;
a projection section for projecting light emitted from said light source;
an alteration section for altering a projection magnification of said projection section so as to change a size of a three-dimensional image to be projected based upon said size data.

8. An apparatus for displaying a three-dimensional image in a space, comprising:
an image data storage section for storing data for displaying a three-dimensional image of a display subject;
a size data storage section for storing data related to a display size of said display subject; and
a display section for displaying said three-dimensional image of said display subject in said space in a size based upon said data related to said display size that has been stored, by using said data for displaying said three-dimensional image that has been stored.

9. The three-dimensional image display apparatus according to claim 8, wherein said display section comprises:
a screen that is shifted in a space;
an optical image generation section for generating an optical image of a cross-section of said display subject in synchronism with an operation of said screen; and
an optical system for carrying out a variable magnification on said optical image that has been generated, based upon data related to said display size that has been stored, and for projecting said optical image onto said screen,
wherein said three-dimensional image is displayed by utilizing an after-image of said optical image projected on said screen that is being shifted.

10. The three-dimensional image display apparatus according to claim 8, wherein said display section comprises:
a screen that is shifted in a space;
a signal generation section for generating a signal representing a cross-sectional image of said three-dimensional image based upon data related to display size that has been stored; and
an optical image generation section for generating said optical image based upon a signal generated in synchronism with said operation of said screen,
wherein said three-dimensional image is displayed by utilizing an after-image of said optical image projected on said screen that is being shifted.

11. An apparatus for displaying a three-dimensional image, comprising:
a screen that is shifted in a space;
an optical image generation section for generating an optical image of a cross-section of said display subject in synchronism with an operation of said screen;
an information acquiring section for acquiring information related to display size of said display subject;
an optical system having a zooming function for projecting said optical image that has been generated onto said screen, said optical image projected on said screen being allowed to have a variable size by said zooming function; and
a controller for controlling said zooming function of said optical system based upon said information that has been acquired.

12. An apparatus for displaying a three-dimensional image, comprising:
a screen that is shifted in a space;
a signal generation section for generating a signal corresponding to a cross-sectional image of a display subject;
an information acquiring section for acquiring information related to display size of said display subject;
an optical image generation section for generating an optical image of said cross-sectional image represented by said signal that has been generated in a size based upon said display size, in synchronism with an operation of said screen; and
an optical system for projecting said optical image that has been generated onto said screen,
wherein said cross-sectional image is displayed in said display size on said screen.

13. An apparatus for displaying a three-dimensional image, comprising:
an image display section for displaying a three-dimensional image formed by an optical image by using a three-dimensional image signal having display size information; and
an information display section for outputting information related to a magnification related to a display size of said three-dimensional image displayed by said image display section.

14. The three-dimensional image display apparatus according to claim 13, further comprising:
an operation section used by an operator so as to specify a magnification; and
a correction section for correcting an optical image of said three-dimensional image so as to be displayed in a specified magnification on said operation section,
wherein said information display section displays said specified magnification.

15. An apparatus for displaying a three-dimensional image, comprising:
an image storage section for storing a signal for displaying a three-dimensional of a display subject;
a size storage section for storing actual dimensional information of said display subject;
a receiving section for receiving a specified magnification; and
a display section for displaying said three-dimensional image of said display subject by using said signal stored in said image storage section, said three-dimensional image being allowed to have a size obtained by variably magnifying an actual dimension of said display subject derived from said actual dimensional information based upon said specified magnification.

16. A data file format for representing three-dimensional information of an object, comprising:
a three-dimensional shape area representing data related to a three-dimensional shape of said object; and
a size area representing data related to a display size of said object.
